(19) United States
(12) Patent Application Publication
(10) Pub. No.: US 2026/0220534 A1
(43) Pub. Date: Jul. 30, 2026

(54) SCALABLE ADAPTIVE SAMPLING METHODS FOR SURROGATE MODELING USING MACHINE LEARNING

(71) Applicant: University of Pittsburgh - Of the Commonwealth System of Higher Education, Pittsburgh, PA (US)

(72) Inventors: Lev KHAZANOVICH, Sewickley, PA (US); Haoran LI, Pittsburgh, PA (US); Sushobhan SEN, Pittsburgh, PA (US)

(73) Assignee: University of Pittsburgh - Of the Commonwealth System of Higher Education, Pittsburgh, PA (US)

(21) Appl. No.: 19/143,802

(22) PCT Filed: Jan. 8, 2024
(86) PCT No.: PCT/US2024/010695

§ 371 Date: Jun. 26, 2025

Related U.S. Application Data
(60) Provisional application No. 63/437,847, filed on Jan. 9, 2023.

(51) Int. Cl. G06N 20/00; G06F 18/21; G06F 30/27; G06F 119/02

(52) U.S. Cl. CPC G06N 20/00; G06F 18/217; G06F 30/27; G06F 2119/02

(57) ABSTRACT

Presented herein are systems and methods of training machine learning (ML) models. A computing system may generate a testing dataset identifying (i) a first plurality of data points defined in a feature space and (ii) a first plurality of outputs in accordance with a function to be performed. The computing system may apply the first plurality of data points to a ML model to generate a corresponding second plurality of outputs. The computing system may determine a performance metric for each data point based on a comparison between corresponding outputs from the first and second pluralities of outputs. The computing system may select, from a second plurality of data points of a training dataset defined in the feature space, a second subset using the first subset. The computing system may retrain the ML model using the second subset and a corresponding third outputs in accordance with the function.

### CROSS REFERENCE TO RELATED APPLICATIONS

The present application claims the benefit of priority to U.S. Provisional Patent Application No. 63/437,847, titled “Scalable Adaptive Sampling Methods for Surrogate Modeling Using Machine Learning,” filed Jan. 9, 2023, which is incorporated herein by reference in its entirety.

### BACKGROUND

A computing system can use various models to analyze data to generate an output.

### SUMMARY

Surrogate modeling is an efficient approach for approximating the results of experiments, analytical models, or high-fidelity computer simulations in physics and engineering. Surrogate models can be developed using data-driven machine learning techniques that sample data from the original model. In many cases, one-shot sampling requires a large number of samples to capture local non-linear behavior. Adaptive sampling has been used as an alternative to generate new training samples iteratively, using the information derived from the surrogate model developed from the previous iteration. The “curse of dimensionality,” however, makes adaptive sampling intractable in a high-dimensional inference space, due to the exponential increase in required sample size.

To overcome this, presented is a scalable adaptive sampling method that can use random points for testing but can generate new training samples as a subset of a full factorial sample, which the resolution becomes finer with each iteration. This algorithm was evaluated on several illustrative examples with analytical solutions, as well as practical case studies from civil engineering with a neural network surrogate model. For a 4D inference space, the surrogate models derived from the proposed method has an order of magnitude lower error than those derived from one-shot sampling with the same sample size. For a 6D inference space, the sample size used by the proposed method was only 5% of that required by one-shot sampling for similar performance. Therefore, the proposed adaptive sampling method can enable an optimal sample distribution and reduced sampling size for accurate yet scalable surrogate modeling, especially for high-dimensional inference spaces.

Various aspects of the present disclosure are directed to systems and methods of training machine learning (ML) models. One or more processors may identify a testing dataset identifying (i) a first plurality of data points defined in a feature space and (ii) a first plurality of outputs expected for the corresponding first plurality of data points in accordance with a function to be performed. The one or more processors may apply the first plurality of data points to a ML model to generate a corresponding second plurality of outputs. The one or more processors may determine a performance metric for each data point of the first plurality of data points according to a comparison between a first output of the first plurality of outputs and a second output of the second plurality of outputs. The one or more processors may identify, from the first plurality of data points, a first subset of data points based on the performance metric for each data point of the first plurality of data points. The one or more processors may select, from a second plurality of data points defined in the feature space for the function, a second subset of data points using the first subset of data points. The one or more processors may retrain the ML model using the second subset of data points and a corresponding third plurality of outputs in accordance with the function.

In some embodiments, the one or more processors may identify, using a pattern defined in the feature space, the second plurality of data points. In some embodiments, the one or more processors may generate the third plurality of outputs corresponding to the second plurality of data points according to the function.

In some embodiments, the one or more processors may identify a number of iterations that the ML model has been trained. In some embodiments, the one or more processors may select, from a plurality of patterns defined in the feature space, a pattern with which to identify the second plurality of second data points. The pattern may have a resolution corresponding to the number of iterations.

In some embodiments, the one or more processors may determine a second performance metric of the ML model, according to the comparison for each data point of the first plurality of data points. In some embodiments, the one or more processors may retrain the ML model using the second subset of data points, responsive to the second performance metric not satisfying a training criteria.

In some embodiments, the one or more processors may determine a second performance metric of the ML model, according to the comparison for each data point of the first plurality of data points. In some embodiments, the one or more processors may determine to stop additional retraining of the ML model, responsive to the second performance metric satisfying a training criteria.

In some embodiments, the one or more processors may identify, from the first plurality of data points, a third subset of data points each corresponding to the performance metric being less than a threshold value. In some embodiments, the one or more processors may exclude, from retraining of the ML model, a fourth subset of data points selected from the second plurality of data points using the third set of data points.

In some embodiments, the one or more processors may identify the first subset of data points each corresponding to the performance metric being greater than or equal to a threshold value. In some embodiments, the one or more processors may identify, for each first data point of the first subset of data points, at least one second point from the second plurality of data points based on a distance between the first data point of the first subset of data points and the at least one second data point.

In some embodiments, the function may include a multi-variate function derived from empirical measurements having one or more local extrema within the feature space. In some embodiments, the function which the ML model may be to stimulate comprises a pavement design mechanistic-empirical (ME) design; the first plurality of data points include a corresponding plurality of variables associated with pavement; and the first plurality of outputs identify fatigue damage to the pavement.

### BRIEF DESCRIPTION OF THE DRAWINGS

The accompanying drawings constitute a part of this specification, illustrate an embodiment, and together with the specification, explain the subject matter of the disclosure.

FIG. 1 shows a sampling process of one example embodiment of the proposed scalable adaptive sampling method.

FIG. 2 provides a visualization of analytical response surface of Shekel Function, in accordance with an example embodiment.

FIGS. 3(A)-(D) show a sampling distribution and neural network prediction surface using an example method for surrogate modeling of Shekel Function at the end of (A) iteration: 1; (B) iteration: 4; (C) iteration: 8; and (D) iteration: 11.

FIG. 4 provides a visualization of analytical response surface of Peak Function, in accordance with an example embodiment.

FIGS. 5(A)-(D) show a sampling distribution and neural network prediction surface using an example method for surrogate modeling of Peak Function at the end of (A) iteration: 1; (B) iteration: 4; (C) iteration: 8; and (D) iteration: 11.

FIG. 6 provides a visualization of analytical response surface of Ackley Function, in accordance with an example embodiment.

FIGS. 7(A)-(D) show a sampling distribution and neural network prediction surface using scalable adaptive sampling for surrogate modeling of Ackley Function at the end of (A) iteration: 1; (B) iteration: 9; (C) iteration: 17; and (D) iteration: 25, in accordance with an example embodiment.

FIGS. 8(A) and (B) illustrate prediction error (MSE) for two benchmark testing datasets (A) LHS random spacing-filling sampling (100 samples); and (B) 8-level full factorial DoE (4096 samples), in accordance with an example embodiment.

FIGS. 9(A)-(D) show an example sensitivity analysis using surrogate neural network models trained with 500 adaptive training samples for (A) COTE; (B) MR; (C) Epcc; and (D) load.

FIGS. 10(A) and (B) show an example comparison of multi-dimensional neural networks derived from one-shot 5-level full factorial DoE and scalable adaptive sampling regarding (A) model performance of benchmark testing datasets; and (B) training sample size and the corresponding ratio between two methods.

FIG. 11 depicts Flowchart of a general surrogate modeling process utilizing adaptive sampling and machine learning.

FIG. 12 depicts Sampling process of the proposed adaptive sampling method in a 2D inference space.

FIGS. 13(A) and (B) depict Mechanism of two modes of fatigue cracking for rigid pavement: (A) bottom-up fatigue cracking; and (B) top-down fatigue cracking.

FIG. 14 is a block diagram of constituent data points for training datasets and testing datasets to be used in training machine learning (ML) models in accordance with an illustrative embodiment.

FIG. 15 is a flow diagram of a process of training machine learning (ML) models in accordance with an illustrative embodiment.

FIG. 16 is a block diagram of a system for training machine learning (ML) models using surrogate modeling in accordance with an illustrative embodiment.

FIG. 17(A) is a block diagram of a process for applying training data to machine learning models in the system for training the machine learning model in accordance with an illustrative embodiment.

FIG. 17(B) is a block diagram of a process for evaluating model performance in the system for training the machine learning model in accordance with an illustrative embodiment.

FIG. 17(C) is a block diagram of a process for sampling data points for retraining in the system for training the machine learning model in accordance with an illustrative embodiment.

FIGS. 18(A) and 18(B) are flow diagrams of a method of training machine learning (ML) models in accordance with an illustrative embodiment.

FIG. 19 is a block diagram of a computing environment according to an example implementation of the present disclosure.

### DETAILED DESCRIPTION

Following below are more detailed descriptions of various concepts related to, and embodiments of, systems and methods for training machine learning models for various applications. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes scalable adaptive sampling for surrogate modeling using machine learning.

Section B describes surrogate modeling of rigid pavements using machine learning with scalable adaptive sampling.

Section C describes systems and methods of training machine learning (ML) models using surrogate model techniques.

Section D describes a describes a network environment and computing environment which may be useful for practicing various embodiments described herein.

### A. Scalable Adaptive Sampling for Surrogate Modeling Using Machine Learning

### 1. Introduction

Surrogate modeling is a method used to approximate solutions from other models, such as experiments, analytical models, and numerical simulations. For many practical physical and engineering problems, surrogate models are used to replace high-fidelity computer-aided simulations, e.g., computational fluid dynamics (CFD) and finite element analysis (FEA), in performing sensitivity analyses, optimizations, or risk analysis for engineering design problems. Surrogate modeling can be applied in speeding up or simplifying engineering simulations, in which one simulation may take anywhere from minutes to days. As a data-driven method, surrogate models can be developed using samples from the models that they are meant to approximate, and their accuracy is highly dependent on the quality of the selected samples. In general, for the same type of model, a surrogate model trained using a larger sample size usually has better performance than when using a smaller sample size. In addition, a well-distributed sample within the inference space usually leads to a surrogate model with a smaller sample size yet good performance.

Surrogate models, such as polynomial response surface (PRS) and radial basis function (RBF), may approach satisfactory performance with a small sample size. However, if a problem is highly nonlinear, these other approaches or methods may have low accuracy, and advanced machine learning (ML) models (e.g., Artificial Neural Networks (ANNs)), can be employed. To develop an accurate surrogate model, the ML techniques usually rely on a large number of samples, especially for a high-dimensional inference space. Thus, while running these ML models is computationally trivial, obtaining enough data to train them is expensive. Therefore, the “curse of dimensionality,” which is related to the number of variables that constitute the inference space, is a significant challenge in surrogate modeling. Without any prior knowledge of the physics of the problem, for a d-dimensional inference space, the number of training points s required scales exponentially as (s^{d}). This exponential increase in the number of training points and the associated computational cost to obtain them from experiment or original model makes it difficult to train high-dimensional surrogate models.

To address this issue, dimensional reduction methods, such as Principal Component Analysis (PCA), sensitivity analysis, partitioning, etc., have been applied. However, these methods either result in parameters that are not physically interpretable or rely on prior knowledge to remove insignificant parameters, which is usually less effective in practical cases. An alternative solution, using an appropriate design of experiment (DoE) to reduce the sample size within the original inference space, can been used.

The DoE can include factorial sampling, central composite design, uniform sampling, etc., which are deterministic sampling methods. Other sampling techniques, such as random sampling, Latin Hypercube Sampling (LHS), Orthogonal Array Sampling (OAS), etc., generate random samples over the entire inference space with a relatively smaller sample size. However, all these sampling methods are “one-shot” sampling (or passive learning), in which both the sample size and distribution in the inference space are determined in a single stage. For a specific surrogate modeling problem without prior knowledge of the problem, these one-shot DoE sampling methods place an equal focus on each variable or dimension of the inference space and may not be able to capture local extrema. As the sample size decreases, the model performance becomes increasingly dependent on the distribution of training samples. However, there is no global standard for estimating the optimal sample size or distribution for surrogate modeling. Since the one-shot DoE typically underestimates or overestimates the optimal sample size and distribution, the derived surrogate models are either less accurate, or computationally expensive to develop. Active learning uses adaptive or sequential sampling to develop accurate surrogate models with fewer sample points. Adaptive sampling can iteratively add new training samples based on information gained from the previous iterations. When used for active ML, the ML model and its parameters are also updated iteratively as new training samples are added. Ultimately, this may result in fewer training points but better distributions than one-shot methods and can lead to more effective and efficient surrogate modeling. Among these applications, ANN models can be applied for the construction of highly nonlinear surrogate models.

However, such implementations may concentrate on low dimensional inference space e.g., 1-dimensional (1D) and 2D inference spaces. Same as one-shot sampling, one reason for this is due to the “curse of dimensionality” of high-dimensional surrogate modeling. Active learning methods, such as uncertainty sampling, query by committee (QBC), version space-based method, expected improvement (EI) algorithm, etc., are applied to achieve satisfied performance with fewer training samples when data are abundant, such as image and natural language data. In this case, a situation that is faced herein entails data lacking, and obtaining training samples that is computationally expensive and time-consuming due to extensive computer simulations to generate data. Some existing adaptive sampling methods e.g., variance-based and gradient-based adaptive sampling, however, do not help to solve this problem because of the application of random sampling techniques for the generation of both training and testing datasets, leading to an exponential increase of sample size with dimensionality.

To overcome this shortcoming, presented herein is a novel scalable adaptive sampling method to develop surrogate models in a high-dimensional inference space. This method can realize scalability by restricting the stochasticity of the candidate training samples. This can be achieved by testing the model at each iteration at randomly sampled points. However, new training points may be (e.g., are only) added from a full factorial DoE, where all the candidate points are deterministic. New training points may be only added from a full factorial DoE (candidate pool), starting from a relatively low but deterministic factorial level, and increasing deterministically with each iteration. This deterministic nature of the candidate new training points can be leveraged/exploited to achieve scalability. This method may be integrated with active ML for the development of complex yet accurate surrogate models.

The rest of the disclosure is structured as follows. Section 2 describes an example embodiment of the proposed approach and demonstrates scalability rigorously. In Section 3, a series of numerical examples is conducted for the application of the proposed technique to three analytical functions to demonstrate the sampling process and verify its effectiveness. In Section 4, an example of the technique is applied to a real-world practical engineering design problem in roadway design. A comprehensive sensitivity study is performed to verify the accuracy, and efficiency of the developed surrogate models using the proposed method and scalability is also demonstrated for this problem. The disclosure presents the conclusion with Section 5. Finally, the disclosure provides an overview of the proposed approach and a computer environment in Sections 6 and 7 respectively.

### 2. Methodology

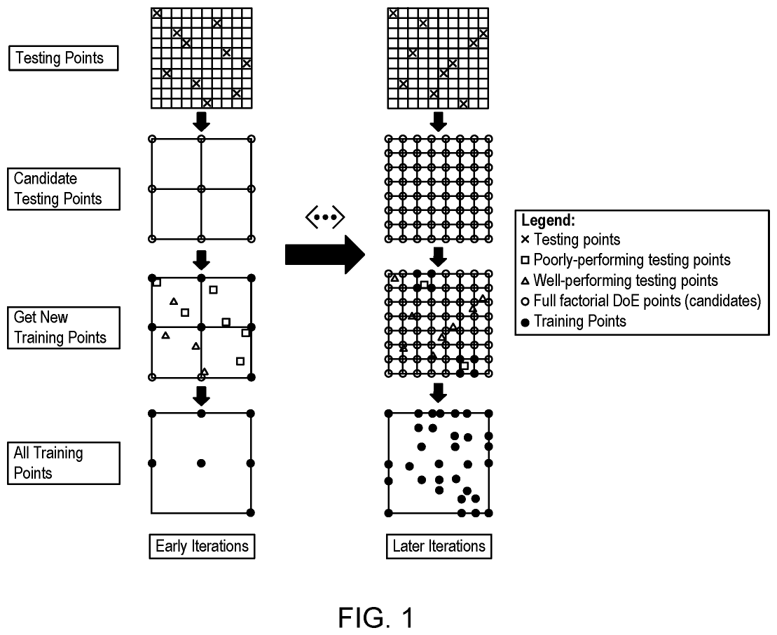

As mentioned previously, randomized sampling for generating the training dataset leads to an exponential increase in sample size for training high-dimensional surrogate models. To overcome this, presented herein is a new scalable adaptive sampling method which can be used in conjunction with active ML to develop a surrogate model for various problems. The general principle of the proposed method is shown schematically in FIG. 1. At each iteration, testing samples may be generated using a random sampling method, e.g., LHS, and applied to test the surrogate ML model derived from the previous iteration. However, a candidate pool for training points may be generated using a full factorial (FF) DoE, which is deterministic. The resolution of the FF DoE mesh points increases with each iteration, leading to a progressively larger but always deterministic candidate pool. Next, new training points can be selected at each iteration from this candidate pool using the information obtained from each testing point. Those remaining (unselected) candidate points are excluded from computer simulations, thus, reducing computational efforts and time. Finally, the new training points can be used to train and update the surrogate ML model. This process may repeat iteratively until a predefined criterion is met. As shown in FIG. 1, the candidate points can have a relatively coarse resolution at early iterations, with the resolution becoming finer at later iterations.

While there can be variations of the general process described above, Algorithm 1 details a particular but non-limiting example implementation that is used in this disclosure. Suppose f(x) is a model that takes a set of inputs x∈ [symbol] and returns a value in [symbol] . A surrogate ML model f_{ML}(x)≈f(x) may be developed in the d dimensional inference space

$${⋃}_{i = 1}^{d} [ {a}_{i} , {b}_{i} ] .$$

Also, suppose [symbol] _{d}(n) represents the set of sample points in an FF DoE of level n∈ [symbol] , and Ω_{d} represents the set of all training data points for the surrogate model at any iteration, which is also represented by n.

The algorithm begins at n=1, in which the training dataset may be bootstrapped with all the factorial points in an n+1 (=2) level FF DoE, [symbol] _{d}(2). At each iteration n, the surrogate ML model can be trained using any suitable training algorithm. Then, a set Γ of testing points may be sampled randomly from the inference space using the LHS technique and tested on the surrogate model. If the mean squared error (MSE) (or any other suitable measure of accuracy) of the testing points is less than a predefined tolerance ε, then the model is deemed to have converged and the algorithm terminates. However, if the model has not converged, for each testing point γ in Γ, a set of new training points ∂ is added to the training dataset. Generally, any appropriate sampling technique S(γ) may be applied for determination of d using the information gained from local or global exploitation, although discussed below, the choice of S(γ) is key for scalability.

```
Algorithm 1 The proposed algorithm (pseudo-code) for developing a
surrogate ML model
Input: Set Ω_{d} = φ; Iteration number n = 1; Tolerance = ε
While n < maximum iterations:
  If n == 1 then:
    Get full factorial training points [symbol]  _{d} (n + 1) and f( [symbol] _{d} (n + 1))
    Set Ω_{d} = [symbol]  _{d} (n + 1) ∪ Ω_{d}
  Else:
    Train an ML model f_{ML} over Ω_{d}
    Get testing points Γ and f(Γ), f_{ML}(Γ)
    $If \frac{1}{\vert Γ \vert} {‖ f ( Γ ) - {f}_{M L} ( Γ ) ‖}_{2}^{2} \leq ε then :$
      Break
    Else:
      For each γ ∈ Γ:
        $If {‖ f ( γ ) - {f}_{ML} ( γ ) ‖}_{2}^{2} > ε then :$
          Get ∂ = S(γ) and f(∂)
          Set Ω_{d} = Ω_{d} ∪ ∂
        End If
      End For
    End If
  End If
  Set n = n + 1
End While
Return f_{ML}
```

From Algorithm 1, it can be seen that the example algorithm scales linearly with each iteration as O(n), with the scalability with d depending on the scalability of S(γ). If this is defined as S(γ)≡γ, which is a random sampling method, then the scaling becomes exponential as O(|Γ|^{d}). Therefore, function S(γ) may be south which scales better than O(|Γ|^{d}). A function

$$S ( γ ) ≡ {NN}_{k}^{d} ( γ , n + 1 )$$

may be proposed, whose algorithm is shown in Algorithm 2 below. The motivation for this function is, for each testing point γ, to add the k nearest neighbors around γ that belong to the next (n+1) level factorial from a full factorial DoE, [symbol] _{d}(n+1). Thus, while the testing points are random, the set of new training points a are selected from a candidate pool that is deterministic and can be determined efficiently, which allows for reducing the number of computations and thus improving scalability.

As shown in Algorithm 2, a main parameter of the proposed function is the search width SW, which is predefined by the user. The algorithm proceeds as follows. For each dimension i, the algorithm may loop through one dimension at a time. In each dimension, dωᵢ represents the size of the interval of that dimension in the factorial set [symbol] _{d}(n) and is evaluated first. Recall that

$$S ( γ ) ≡ {NN}_{k}^{d} ( γ , n + 1 ) ,$$

and so the function may actually be called at the next (n+1) level factorial [symbol] _{d}(n+1) as the iteration number n in Algorithm 1; the following discussion, however, is for any n passed as an argument to

$${NN}_{k}^{d} ( γ , n ) .$$

Next, the variable ηᵢ is the ordinal number of the nearest point just before the projection of the testing point γ·êᵢ in the n level factorial and can be evaluated efficiently through an O(1) operation. Then, for a given SW, dωᵢ and ηᵢ can be used to efficiently generate a set of points Nᵢ that are within SW in both negative

$$( {N}_{i}^{-} )$$

and positive

$$( {N}_{i}^{+} )$$

directions and also within the bounds of the inference space [aᵢ, bᵢ]. SW thus determines the total number of candidate points in each dimension. All the sets of points in each dimension Nᵢ are then meshed to constitute the candidate pool N for the new training samples for each testing point γ. The total number of such points can be shown to be (2SW)^{d} and they are always a subset of [symbol] _{d}(n). The last step of the algorithm is to obtain the k nearest neighbors (in terms of Euclidean distance) ρ to each of the testing point γ from the candidate pool N, which uses at most k evaluations. While k is a user-specified input to the function, it is bound by k≤(2SW)^{d}. A value of 1 or 2 for SW and k<<(2SW)^{d} for a reasonably large d are also usually sufficient. The function can finally return the set of new training points ρ, and Algorithm 1 proceeds as discussed previously.

```
$Algorithm 2 Nearest neighbor ( N N \frac{d}{k} ( γ , n ) ) algorithm ( pseudo - code )$
Input: Set a sufficiently large search width SW ∈ [symbol]  , inference space
dimension = d, factorial level = n, number of nearest neighbors =
k ≤ (2SW)^{d}
For i = 1 to d:
  $Define d {ω}_{i} = ( \frac{{b}_{i} - {a}_{i}}{n - 1} )$
  Define γᵢ = γ · êᵢ
  $Get {η}_{i} := floor ( \frac{{γ}_{i} - {a}_{i}}{{dw}_{i}} )$
  $Define {N}_{i}^{-} := {⋃}_{j = 0}^{S W - 1} [ {a}_{i} + ( {η}_{i} - j ) d {ω}_{i} ] , ( {η}_{i} - j ) \geq 0$
  $Define {N}_{i}^{+} := {⋃}_{j = 0}^{S W - 1} [ {a}_{i} + ( {η}_{i} + j + 1 ) d {ω}_{i} ] , ( {η}_{i} + j + 1 ) \leq n$
  $Ni = {N}_{i}^{-} ⋃ {N}_{i}^{+}$
End For
Define N := N₁ × N₂ × N₃ × . . . × N_{d}, |N| ≤ (2SW)^{d}
Define ρ = φ
For i = 1 to k then:
  $Set ρ = ρ ⋃ {arg min}_{N} {‖ N - γ ‖}_{2}$
  Set N = N\ρ
    If N = φ then:
      Break
    End If
End For
Return ρ
```

Considering the scalability of Algorithm 2, it can be shown to scale as O((2SW)^{d}), primarily from the Euclidean distance evaluation. Therefore, when Algorithm 1 and 2 are used together for example, the adaptive sampling technique scales as O(n(2SW)^{d}) as compared to a typical random sampling technique, which scales as O(n|Γ|^{d}). Typically, 2SW is a small, constant value compared to |Γ|i.e.,

$$\frac{2 SW}{\vert Γ \vert} << 1 ,$$

and so the proposed technique scales much better than typical random sampling with the dimensionality of the inference space. Furthermore, it also scales much better than a one-shot, full factorial approach, which scales as (n^{d}).

### 3. Illustrative Examples

The methodology illustrated above is applied to several simple examples for demonstrating its effectiveness. Three illustrative examples, Shekel Function, Peak Function, and Ackley Function, were applied, in the inference spaces [0,10]², [−3,3]², and [−2,2]², respectively. The proposed method is used to train surrogate ANN models for each of these functions. The results are discussed below.

### 3.1 Shekel Function

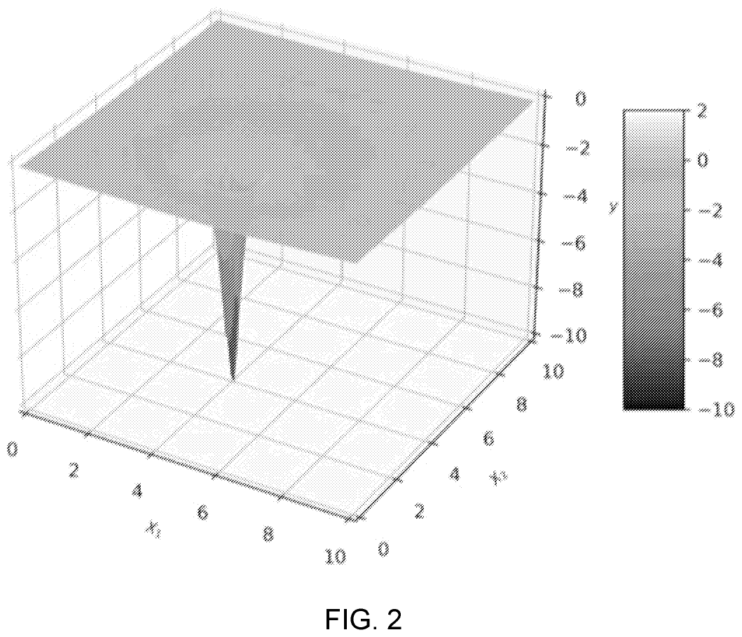

A 2D version of the Shekel Function is utilized. FIG. 2 visualizes the analytical response surface. It shows that the Shekel Function has a sharp minimum of −10.54 at the point (4,4). Except for this minimum and the space near it, the function is relatively flat.

For the implementation of the proposed method and ML neural networks for surrogate modeling, a software library such as TensorFlow (version 2.9.1) may be used. The settings and hyperparameters for both the proposed sampling algorithm and the ML neural networks can be summarized in Table 1. It may be noted that since the proposed technique may rely on random sampling for the testing points, 10 ensemble runs for instance can be performed for each model to eliminate any bias due to the random sampling.

TABLE 1
Settings of hyperparameters for the proposed
algorithm and neural networks

| Settings | Hyperparameters | Values |
|---|---|---|
| Proposed | Inference space dimension (d) | 2 |
| Sampling | Number of LHS test points at | 20 |
| Method | each iteration (\|Γ\|) | |
| | Search width (SW) | 2 |
| | Number of nearest neighbors (k) | 3 |
| | Tolerance (ε) | 10⁻³ |
| | Max iteration number | 50 |
| Neural | Architecture | 2 hidden layers, with 10 |
| Networks | | neurons in each layer |
| | Activation function | Hyperbolic tangent (tanh) |
| | Optimizer | Adam |
| | Loss function | Mean Squared Error (MSE) |
| | Number of ensemble models | 10 |

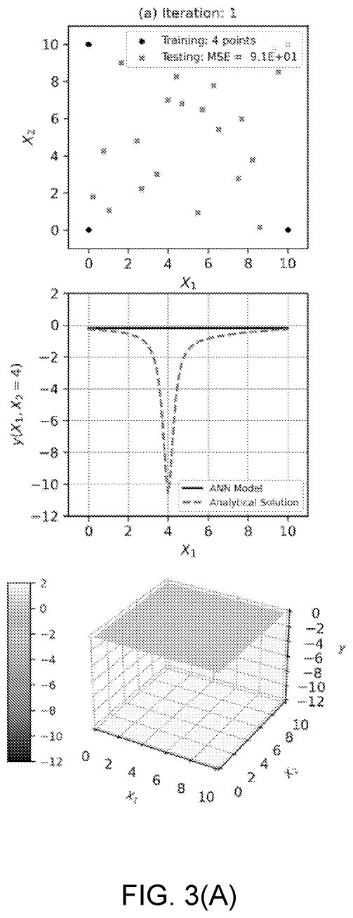

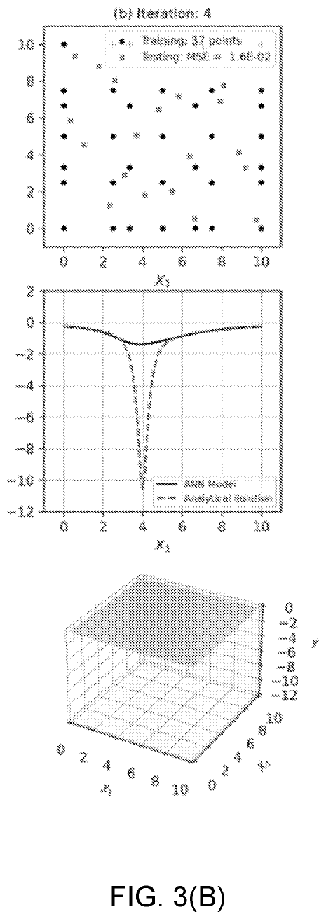

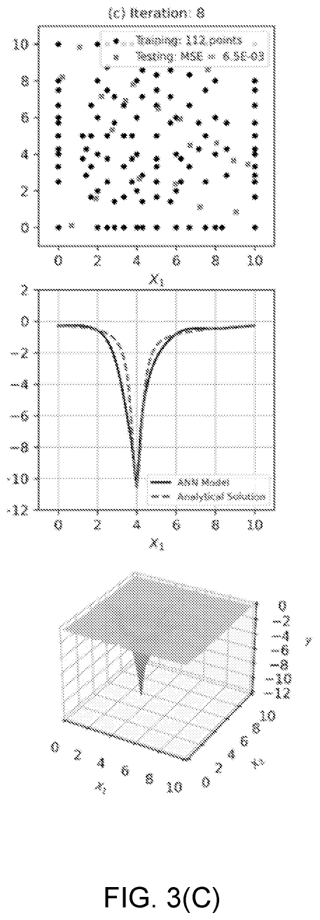

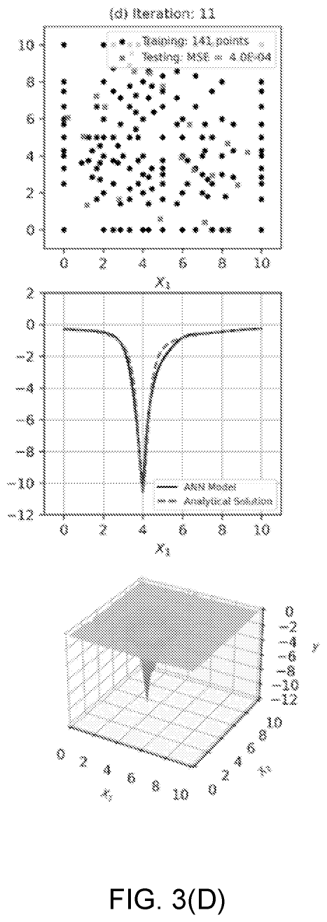

FIG. 3(A) to (B) shows the distribution of the training and testing samples and the resulting response surfaces by the ensemble surrogate ANN model predictions for increasing iterations of the algorithm. In general, it can be seen that while the predicted response surface is initially quite different from the analytical solution, the accuracy improves significantly as the algorithm progresses. To evaluate the performance of the models, the prediction accuracy at the minimum at point (4,4), which shows the local performance, was looked at. The accuracy at points in the relatively flat area, which shows the global performance, was also looked at. To quantify the local performance, the minimum predicted value was compared to the analytical value, −10.54. To measure the global performance, the ensemble mean MSE of the testing points was computed.

As shown in FIGS. 3(A) and (B), at early iterations, the training samples are relatively sparse in the given 2D space, and the sample size increases slowly. At later iterations, as shown in FIGS. 3 (C) and (D), the new training points are sampled from a finer mesh, with a relatively larger increase in sample size as compared to the early iterations. The ensemble mean MSE decreases with each iteration, indicating an improving global performance of the ANN models. At iteration 11 (FIG. 3 (D)), the MSE reaches 4.0×10⁻⁴, reflecting convergence. At early iterations (FIGS. 3 (A) and (B)), the surrogate ANN models predict a minimum of −0.18 and −1.37 at point (4,4) at iterations 1 and 4, respectively, which have a relatively large error as compared to the analytical value of −10.54. However, from iterations 4 to 8 (FIGS. 3 (B) and (C)), the predicted minimum value improves significantly from −1.37 to −10.45. Finally, the predicted minimum value reaches −10.47, at iteration 11 (FIG. 3 (D)). Regarding the training sample distributions, as shown in FIGS. 3 (A) and (B), the training samples at early iterations tend to be scattered, filling the entire inference space. However, for later iterations (FIGS. 3 (C) and (D)), most of the new training points were sampled around the nonlinear area. This demonstrates that the proposed method is capable of sampling more sample points in the nonlinear region, resulting in a more accurate surrogate modeling around the local extremum. It can be concluded that the surrogate ANN models developed using the proposed method perform well both locally (e.g., in the nonlinear region) and globally for the Shekel Function.

### 3.2 Peak Function

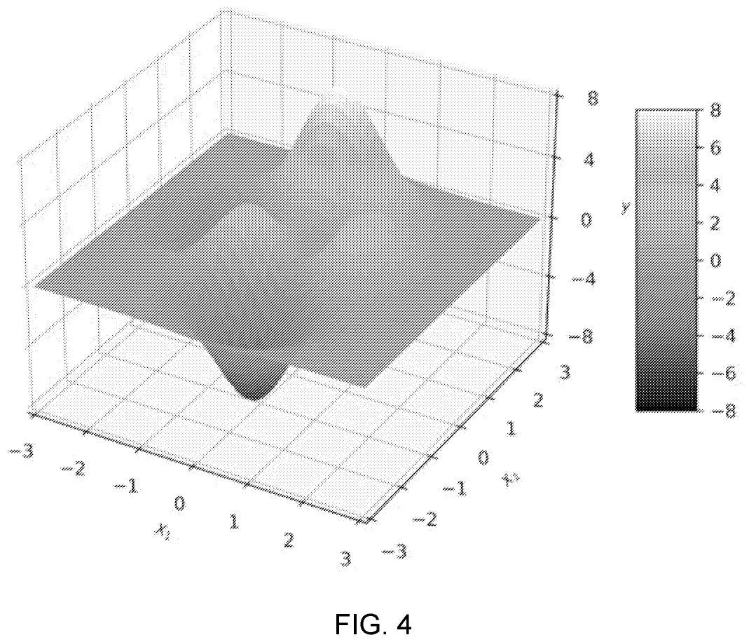

FIG. 4 represents the analytical solution surface of the Peak Function, with several local extrema and relatively flat areas in between, which is more nonlinear than the Shekel Function. For surrogate modeling of the Peak Function, ANN models were trained using the proposed method, with the same settings as shown in Table 1. Similarly, to evaluate the global accuracy of the developed ANN models, the averaged performance of the space-filling testing points is examined at each iteration, using the ensemble mean MSE. The local performance was qualitatively evaluated, by investigating when and how the local extrema were captured by the ANN predictions, in comparison with the analytical solution (FIG. 4).

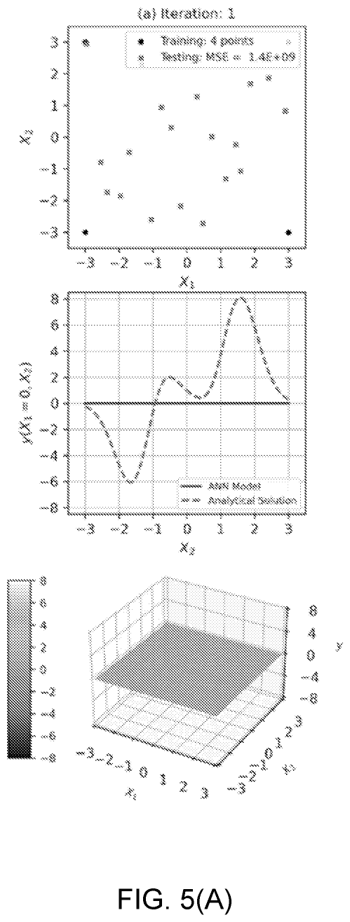

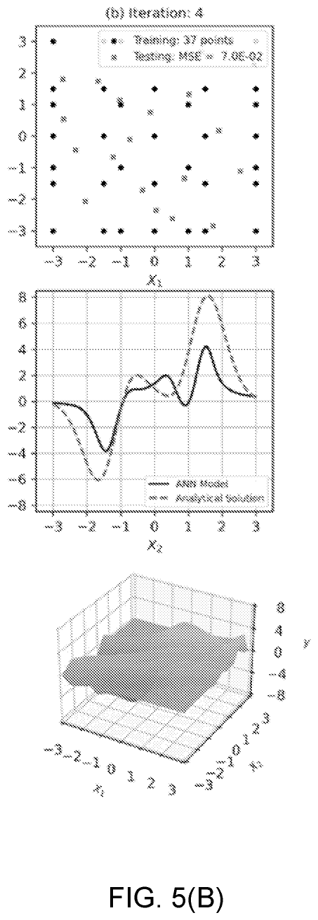

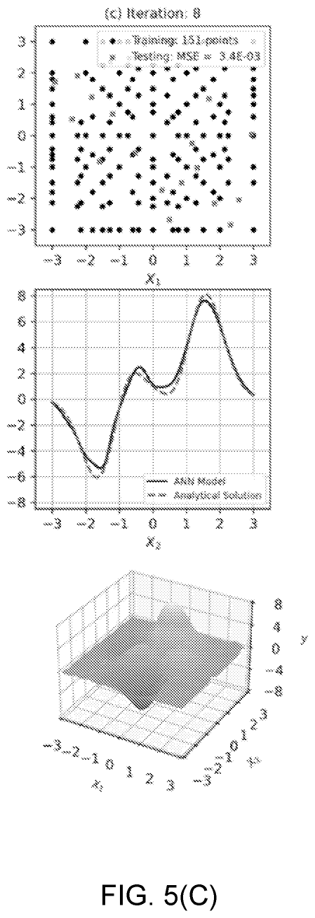

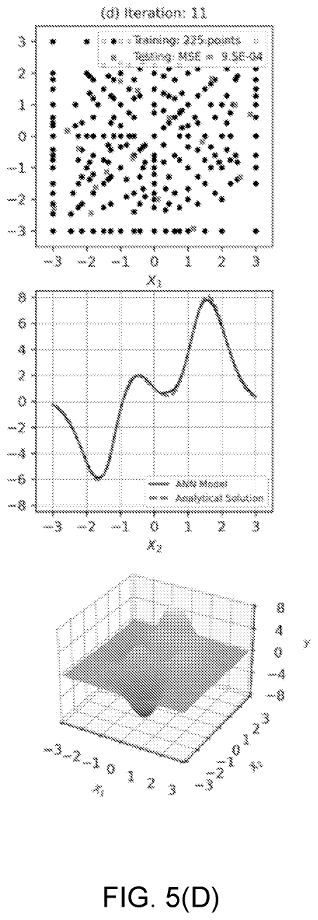

FIG. 5 visualizes the corresponding sampling distributions as well as predicted response surfaces for increasing iterations. It can be observed from FIGS. 5 (A) and (B) that the ensemble mean MSE has improved significantly, showing that the algorithm prioritizes global performance at early iterations. The responses of ANN predictions at iteration 4 also show a visible improvement from iteration 1, with multiple local extrema beginning to appear. At iteration 8 (FIG. 5 (C)), the MSE was significantly improved, from 7.0×10⁻² (iteration 4) to 3.4×10⁻³, with only 114 training points being added. In addition, the neural networks captured all the peaks and valleys and the surrounding transition areas, showing that the algorithm is able to find local extrema. The difference between iteration 11 (FIG. 5 (D)) and iteration 8 is relatively small in terms of the local extrema, but the MSE was improved from 3.4×10⁻³ to 9.5×10⁻⁴, indicating convergence, with only 225 well-distributed training samples. The final training samples are distributed tightly around the extrema and sparsely in between. This confirms the efficiency and effectiveness of the proposed method in surrogate modeling of the Peak Function (e.g., in addressing local extrema).

### 3.3 Ackley Function

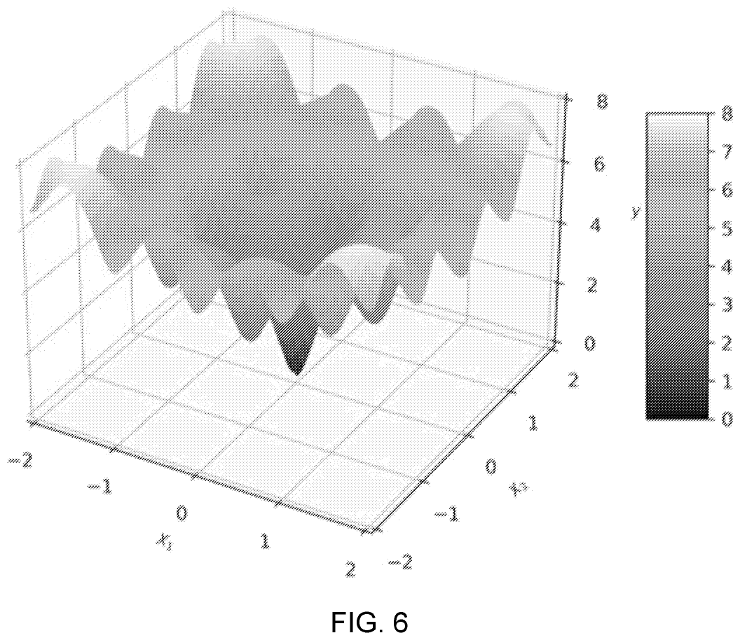

Finally, a 2D version of the Ackley Function may be considered to develop a surrogate model. FIG. 6 represents the response surface, which has the largest number of local extrema and is the most complex of the three functions due to its more oscillatory and highly nonlinear behavior. Surrogate ANN models, utilizing the same setting parameters as other functions (Table 1), were trained and updated iteratively using the proposed method. In this case, the global performance in terms of the ensemble mean MSE may be examined.

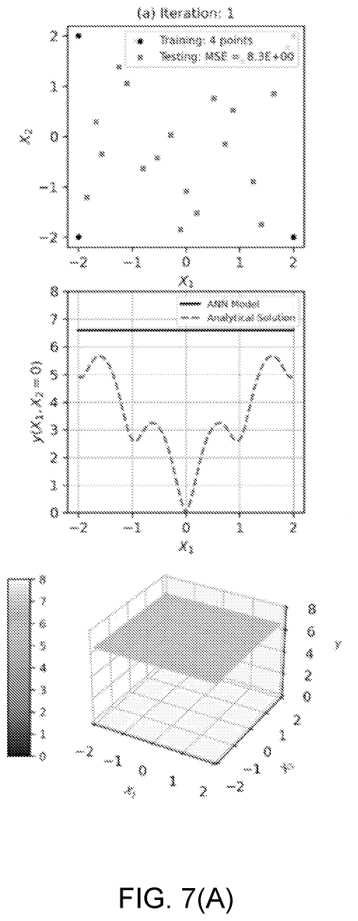

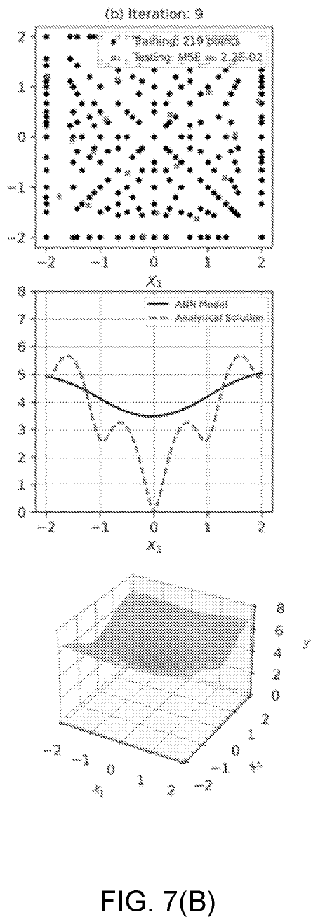

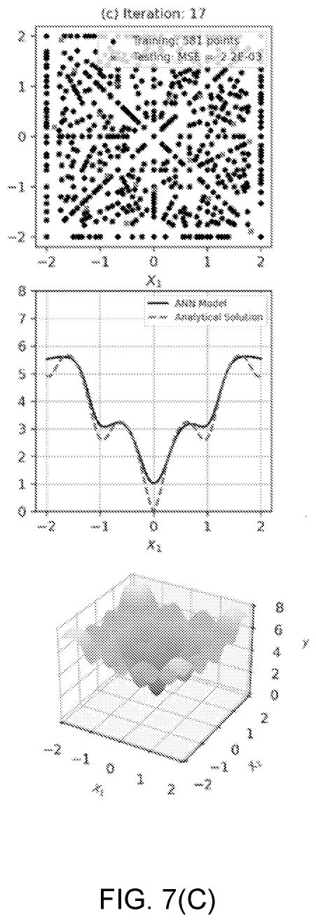

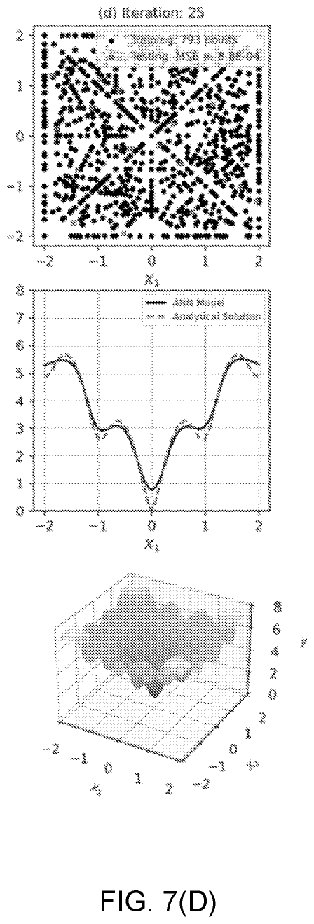

FIG. 7 shows the sample distribution and the predicted response surfaces at representative iterations, respectively. As shown in FIG. 7 (A), only 4 training points were applied for surrogate modeling at iteration 1, resulting in a flat prediction surface with an ensemble mean MSE of 8.3. Starting from the 9^{th} iteration (FIG. 7 (B)), the surrogate ANN models start to capture the nonlinear behavior but may not be able to resolve the local extrema with 219 training samples. The ensemble mean MSE was improved to 2.2×10⁻². At the 17^{th} iteration (FIG. 7 (C)), the improved distribution of 581 training samples enables full capture of all the local extrema, with the ensemble mean MSE decreased to 2.2×10⁻³. Finally, with 212 new training samples being added, the MSE was 8.8×10⁻⁴ at iteration 25, indicating convergence. Compared to the surrogate modeling of the Shekel Function (FIG. 3) and Peak Function (FIG. 5), both the iteration number meeting convergency and corresponding training points of the Ackley Function are much higher than the other two, due to the highly nonlinear behavior.

It can thus be concluded that the proposed new technique is capable of capturing nonlinearity in low-dimensional benchmark problems. For each of the problems, different well-distributed training points were sampled adaptively, without any prior knowledge of the solution. In the next section, an application of the method to a practical engineering problem is discussed, and its scalability with respect to dimensionality is demonstrated.

### 4. Case Study

Pavements (or roads) form the backbone of logistics networks around the world and billions of dollars are spent each year on building and maintaining them. Among these, rigid (or concrete) pavements, which have a Portland Cement Concrete (PCC) surface, tend to be preferred on the most important routes that carry trucks. Proper design of rigid pavements is therefore of critical importance to society at large. Modern pavement design uses a mechanistic-empirical (M-E) approach, in which the damage accumulated by a rigid pavement over its entire life (usually 20 years or more), with various input factors such as traffic load, climate, material properties, etc., is estimated using mathematical models and ensured to be below some specified threshold. These mathematical models are typically solved numerically. In this section, the application of the proposed method to develop a surrogate model for the design of rigid pavements is presented.

The underlying model for rigid pavement design used is the American Association of State Highway and Transportation Officials (AASHTO) Mechanistic-Empirical Pavement Design Guide (Pavement ME), which is widely used in the US and Canada. The model uses over 200 input parameters, which can be broadly classified into climate conditions, traffic loads, material properties, and geometry, to calculate the damage accumulated by the pavement. The damage is quantified in terms of the fatigue damage accumulated on the pavement over its lifetime. To find an optimum design, the designer needs to determine the combinations of the input parameters that result in an acceptable level of fatigue damage at the end of the design life. This requires numerous simulations of Pavement ME, which can be quite time-consuming. Several faster surrogate models have been developed to speed up the process. These other models used one-shot sampling and training over a classical partial or full factorial DoE and inherently suffered from the exponential growth rate of the sample size with the dimensionality of the inference space. As a result, they accounted for only a limited number of inputs.

The proposed method may be applied to develop a high-dimensional surrogate model of Pavement ME while limiting the number of training samples. Six variables that have been shown to significantly influence damage to pavements are considered. These are: the PCC elastic modulus (Epcc), which is a measure of the stiffness of the pavement; the PCC modulus of rupture (MR), which is a measure of the strength of the pavement; the PCC coefficient of thermal expansion (COTE), which is a measure of the sensitivity of the pavement to thermal expansion; the load of the axle passing over the pavement; the thickness of the pavement; and the spacing between the joints. First, an initial 4D inference space is considered to demonstrate the accuracy of the model developed using this method. Then, the dimensionality of the inference space is increased to demonstrate scalability as compared to the one-shot DoE. While six variables were sufficient for this study, the method can be extended to include more as well.

### 4.1 Initial Model

As a first step, a 4D inference space consisting of the COTE, MR, Epcc, and traffic load. All other input values to the model were fixed to typical values applied in rigid pavement design. Pavement M-E was used to evaluate the response of the model in this 4D inference space. Ten ensemble neural networks with the same architecture as the illustrative examples (Table 1) were trained over the inference space shown in Table 2. To compare the performance of these neural networks to a one-shot approach that has been used in previous work, several neural networks with 10-fold cross-validation were also trained using one-shot training over various levels of full factorial DoE (2 to 7-level) with the same architecture.

TABLE 2
The inference space and design variables with corresponding
lower and upper bounds for the given 4-dimensional case study

| | PCC coefficient of | PCC modulus | PCC elastic | |
|---|---|---|---|---|
| Inference | thermal expansion | of rupture | modulus | Load |
| Space | (10⁻⁶° C.⁻¹) | (MPa) | (MPa) | (kN) |
| Lower | 7.2 | 3.45 | 20700 | 35.6 |
| Limit | | | | |
| Upper | 10.8 | 6.21 | 41400 | 178 |
| Limit | | | | |

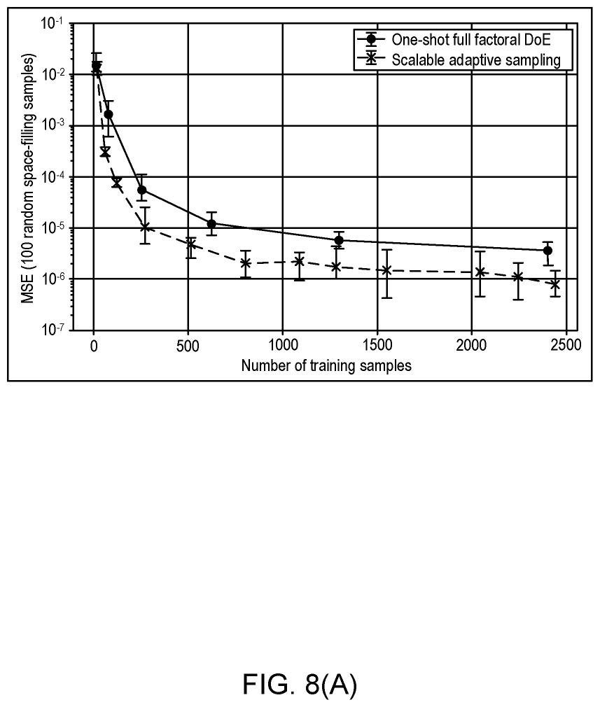

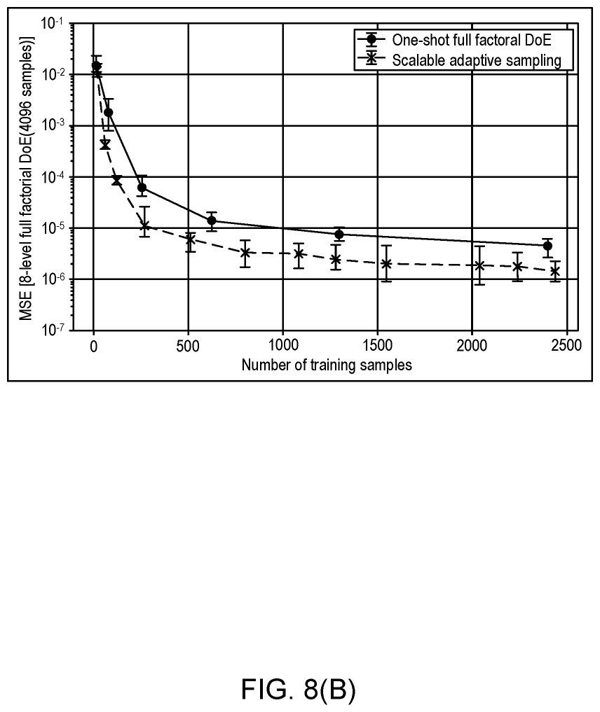

The performance of the ML neural networks and the one-shot full factorial DoE ones was compared by evaluating their MSE on two independent benchmark datasets: a sample consisting of 100 samples obtained using LHS random spacing-filling sampling and an 8-level full factorial DoE (4096 samples). FIGS. 8 (A) and (B) show the MSE for the two benchmark datasets, respectively. It can be seen that both datasets have a decreasing MSE and improved model performance with an increase in sample size. However, the neural networks trained using the proposed method perform better (roughly by an order of magnitude) than those obtained using the one-shot full factorial DoE for the same number of training points. For the same MSE, the proposed method may use a fraction of training samples, with about a 60% reduction in the required sample size for a mean MSE of 10⁻⁵ and a 70% reduction for 4×10⁻⁶. It can be concluded that for the given 4D inference space, the proposed method can effectively approach a much better performance with a similar training sample size or significantly reduce the training sample size without loss of prediction accuracy as compared to the one-shot approach.

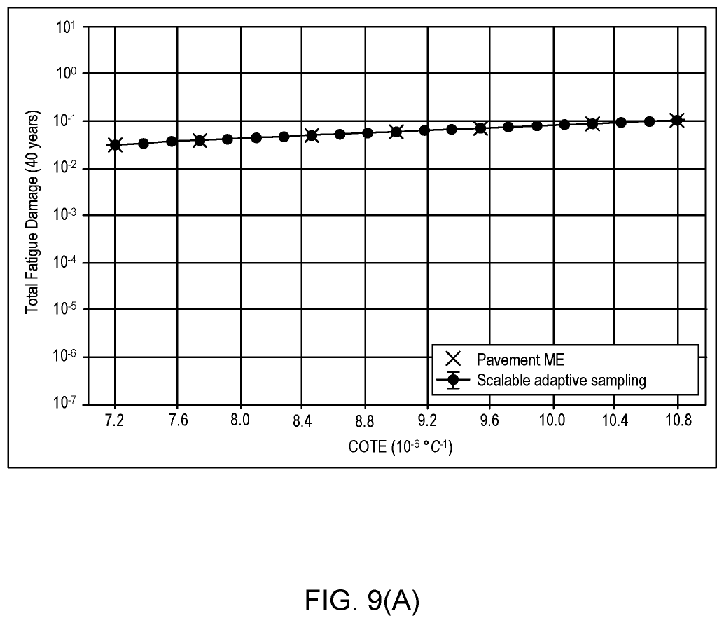

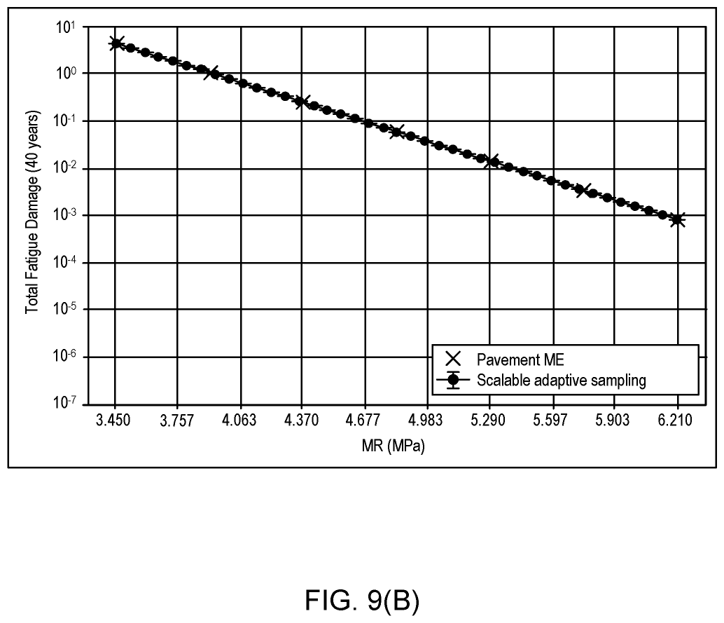

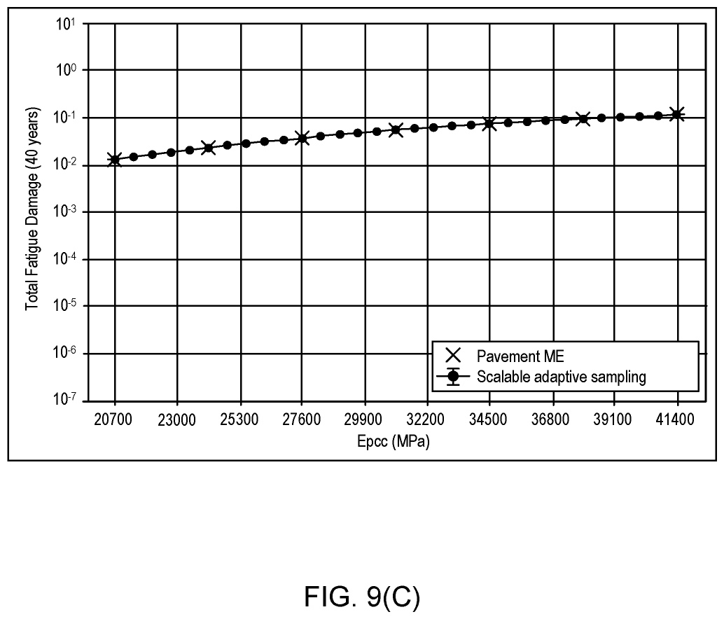

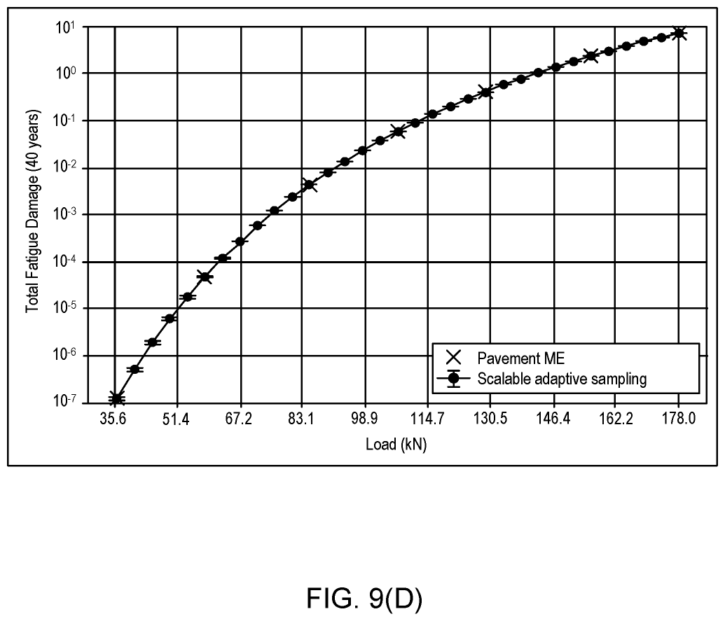

Additionally, sensitivity analyses were performed on each of the four input variables for the neural networks developed using the proposed method to ensure that the predictions did not show any non-physical behavior. In this case, the neural networks that were developed with 500 adaptive sample points were used in this example implementation. These analyses were conducted by varying one parameter at a time while other parameters were kept constant in the middle of the inference space. FIG. 9 (A) to (D) shows the results from the analysis for COTE, MR, Epcc, and load, respectively. Within the inference space, the fatigue damage increased with COTE, Epcc, and load, and decreased with MR. This is consistent with the expected behavior of the pavement. Several additional Pavement M-E runs were also performed and shown in FIG. 9 as additional validation, and all of them showed good agreement with the surrogate neural network model predictions. It can thus be concluded that the surrogate model developed using the proposed method is accurate and can capture the underlying behavior of the system while utilizing fewer sample points than alternative approaches.

### 4.2 Higher-Dimensional Inference Spaces

Another study was performed to demonstrate the scalability of the proposed method in higher-dimensional inference spaces as compared to the full factorial DoE. In this case, the inference space varied from 2D to 6D, as summarized in Table 3. For each of these inference spaces, 10 ensemble surrogate neural network models with the same architecture as before were trained using the proposed adaptive sampling method. Additionally, another set of neural networks trained with one-shot 5-level full factorial DoE from 2D to 6D and 10-fold cross-validation was also developed. To compare the performance of these two, several benchmark testing datasets, at a fraction of 40%, 15%, 10%, 10%, and 10% of the 5-level full factorial DoE from 2D to 6D, respectively, can be generated using the LHS method.

TABLE 3
The inference space and design variables with corresponding lower
and upper limits or fixed values for the given 2D-6D case study

| | | | | PCC | | | |
|---|---|---|---|---|---|---|---|
| | | PCC | | coefficient | | | |
| | | modulus | PCC | of thermal | | | |
| | | of | elastic | expansion | | PCC | Joint |
| | | rupture | modulus | (10⁻⁶° | Load | thickness | spacing |
| Inference Space | | (MPa) | (MPa) | C.⁻¹) | (kN) | (mm) | (m) |
| Lower Limit | | 3.45 | 20700 | 7.2 | 35.6 | 150 | 3.65 |
| Upper Limit | | 6.21 | 41400 | 10.8 | 178 | 400 | 6.10 |
| Dimensionality | 2D | varied | varied | 9.0 | 106.8 | 275 | 4.88 |
| | 3D | varied | varied | varied | 106.8 | 275 | 4.88 |
| | 4D | varied | varied | varied | varied | 275 | 4.88 |
| | 5D | varied | varied | varied | varied | varied | 4.88 |
| | 6D | varied | varied | varied | varied | varied | varied |

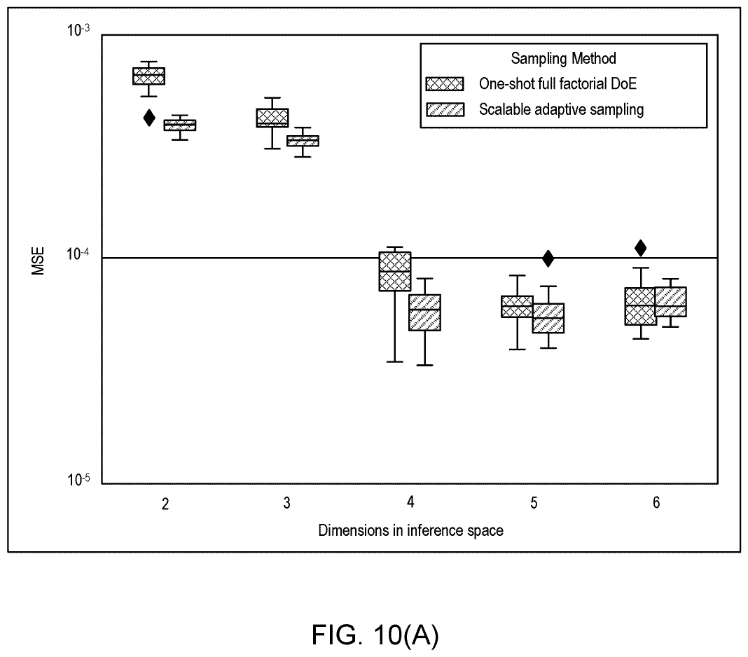

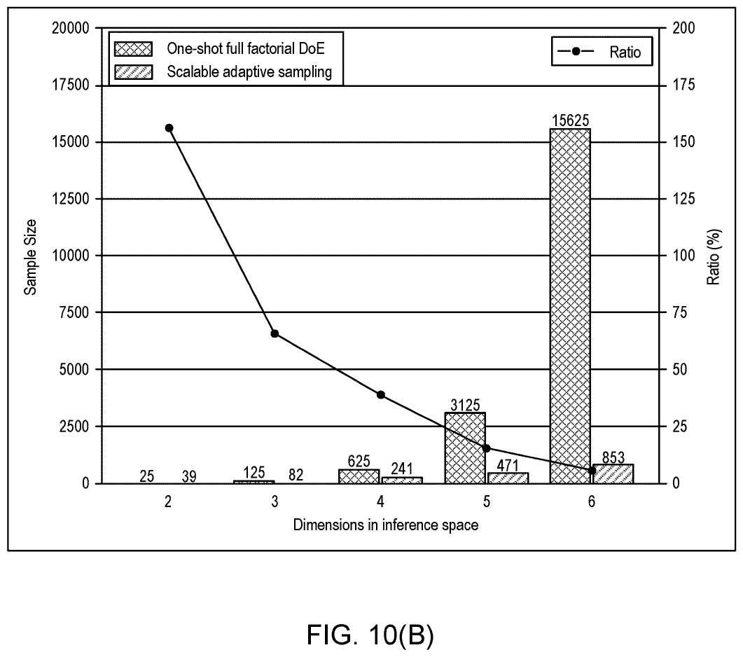

FIG. 10 (A) shows the distribution of the MSE (over cross-validations and ensembles) from benchmark testing datasets using neural network predictions derived from one-shot full factorial DoE as well as the proposed adaptive sampling method. It can be seen that the MSE between the two approaches is comparable in all the inference spaces, with the models developed with the proposed method performing slightly better. FIG. 10 (B) shows the corresponding sample sizes and their ratio between the proposed method and a one-shot approach. It can be seen that the full factorial DoE has an exponentially increasing sample size with the dimensionality of the inference space. In comparison, the sample size for the proposed method grows slowly while still showing comparable performance. For low dimensionality, e.g., 2D, the proposed method results in a larger sample size than a full factorial DoE. However, for higher dimensions (3D and above), the sample size ratio decreases dramatically with respect to dimensionality, as low as 5% for a 6D inference space. This confirms the scalability analysis that was discussed earlier in the disclosure and shows that the proposed method can be used for developing surrogate models in a high-dimensional inference space with a significant reduction of sample size compared to one-shot full factorial DoE.

### 5. Conclusions

Surrogate modeling is an efficient approach for the approximate modeling of high-fidelity computer simulations. However, due to the “curse of dimensionality,” surrogate modeling over a high-dimensional inference space is computationally expensive. This is because of the exponentially increasing sample size with the increase in the number of dimensions considered. Presented herein is a new adaptive sampling method that is scalable for high-dimensional inference spaces and has demonstrated the effectiveness of a particular implementation of it. The proposed method can iteratively apply random sampling for the generation of testing samples to evaluate the developed surrogate models. However, unlike other adaptive random sampling techniques, it can utilize a deterministic full factorial design of experiment (DoE) with iteratively increasing factorial levels for the construction of candidate pools for new training samples. This deterministic nature of the candidate pool enables an efficient algorithm that can scale better with the dimensionality of the problem as compared to the exponential scaling of both other adaptive random sampling methods as well as classical DoE sampling.

Serval illustrative examples with analytical solutions are performed to demonstrate the effectiveness of the proposed method. The results show that the proposed method can effectively and efficiently navigate regions with high local nonlinearity as well as provide satisfactory overall global performance. The proposed algorithm is also applied for surrogate modeling in practical civil engineering case studies. These case studies confirmed the effectiveness of the new adaptive sampling for higher-dimensional inference space. In comparison with one-shot factorial DoE sampling, the surrogate models derived from the scalable adaptive sampling performed better for a similar sample size or used only a small fraction of the sample size to achieve the same performance. For a 4D inference space, the surrogate models derived from the proposed method have an order of magnitude smaller error than the one-shot factorial DoE with the same sample size. For comparable performance, the proposed method used 30% to 40% sample points as compared to a full factorial DoE. Furthermore, the sample size used by the proposed method decreased with dimensionality, utilizing only about 5% of the number of samples as a one-shot full factorial DoE in a 6D inference space. Thus, the proposed method enables the efficient development of accurate, high-dimensional surrogate models.

B. Surrogate Modeling of Rigid Pavements Using Machine Learning with Scalable Adaptive Sampling

### 1. Introduction

Pavements, or roads, are crucial to logistics networks worldwide, and billions of dollars are invested annually in their construction and maintenance. Rigid pavements, which feature a Portland Cement Concrete (PCC) surface, are often favored for the most critical routes that carry heavy truck traffic. Therefore, the proper design of rigid pavements is of significant importance to society and the environment. Modern pavement design employs a mechanistic-empirical (M-E) approach that estimates the damage accumulated by a rigid pavement over its service life (usually 20 years or more), taking into account various input factors such as traffic load, climate, material properties, etc., using mathematical models, and ensuring that the damage remains below a specified threshold. These mathematical models are typically solved numerically. Among these M-E design approaches or guidelines, the American Association of State Highway and Transportation Officials (AASHTO) Mechanistic-Empirical Pavement Design Guide (MEPDG) and its companion software, AASHTOWare Pavement ME Design (Pavement ME), are the underlying model and software tool, respectively, for obtaining optimized design solutions for rigid pavement.

Surrogate modeling is a technique used to approximate solutions from other models, such as experiments, analytical models, and numerical simulations. For many practical physics and engineering problems, surrogate models are used to replace high-fidelity computer-aided simulations, e.g., computational fluid dynamics (CFD) and finite element analysis (FEA), in performing sensitivity analyses, risk analysis, optimizations, or design. Surrogate modeling has been extensively applied in speeding up or simplifying engineering simulations, in which one simulation may take anywhere from minutes to days, such as Pavement ME. As a data-driven method, surrogate modeling uses samples from the models that they are meant to approximate, and their accuracy is highly dependent on the quality of the selected samples. In general, for the same type of surrogate model, a model trained using a larger sample size usually has better performance than when using a smaller sample size. In addition, a well-distributed and informative sampling dataset within the inference space usually leads to a surrogate model with a smaller sample size yet good performance.

The Pavement ME software is extensively used in the US and Canada for the design of pavement systems. Performing a rigid pavement design requires the user to provide over 200 input parameters, which can be broadly classified into climate conditions, traffic loads, material properties, and geometry, to predict pavement behavior. To obtain an optimal design, the designer must identify combinations of input parameters that result in an acceptable level of fatigue cracking at the end of the design life. This necessitates multiple iterations of Pavement ME computational simulations that can be time-consuming, in which one project-level design simulation may take up to hours for Pavement ME to obtain an optimal value of the design inputs. In the past, surrogate modeling has been employed for developing machine learning (ML) models to expedite the process.

Several studies employed ML models in surrogate modeling of Pavement ME to accelerate the implementation of M-E pavement design. These studies have employed various ML models, including the classic regression model, Polynomial Response surface (PRS), Gaussian Process (GP) models, Multi-Gene Genetic Programming (MGGP), etc. However, the development of these models typically requires extensive data, which itself must come from a very large number of Pavement ME simulations. Thus, while running these models is computationally trivial, obtaining enough data to train them is expensive. This issue is caused primarily by the “one-shot” sampling method applied in these studies, in which the training samples are determined in a single stage. Classical Design of Experiment (DoE) techniques, such as factorial sampling, central composite design, and uniform sampling, are common “one-shot” sampling methods. Additionally, randomized “one-shot” sampling methods, such as Monte Carlo (MC) sampling, Latin Hypercube Sampling (LHS), and Orthogonal Array Sampling (OAS), are also widely applied to optimize the sample distribution within the original inference space.

There is currently no global standard for estimating the optimal sample size or distribution for surrogate modeling. In “one-shot” sampling techniques, both the sample size and distribution are pre-defined before training ML models. As a result, they may fail to capture local or global extrema, leading to less accurate surrogate models. The accuracy of the derived models is highly dependent on the sampling method and distribution of training samples, especially as the sample size decreases. “One-shot” sampling often underestimates or overestimates the optimal sample size and distribution, resulting in less accurate ML models or higher costs in obtaining enough data. This issue is commonly known as the “curse of dimensionality,” which is related to the number of independent variables that make up the inference space (i.e., the dimensionality of the problem), presenting a significant challenge in surrogate modeling. Without any prior knowledge of the physics of the problem, for a d-dimensional inference space, the number of training points required scales exponentially as O(s^{d}).

The exponential increase in the number of required training points and the associated cost to obtain them present a significant challenge in training high-dimensional surrogate models using Pavement ME for pavement design. Consequently, “one-shot” sampling has restricted surrogate modeling of M-E pavement design to a limited number of input parameters due to the exponential growth rate of the sample size with the dimensionality of the inference space. Previous studies were therefore only able to develop surrogate models in either low-dimensional inference spaces, such as one-dimensional (1D) and 2D inference spaces, or were only able to develop less sophisticated and less accurate ML models for performing pavement design. Given that pavement design is a high-dimensional optimization problem, the use of low-dimensional surrogate models in the past has been inadequate and can lead to suboptimal designs. However, due to the “curse of dimensionality” in “one-shot” sampling, developing high-dimensional surrogate models is computationally difficult. We, therefore, seek a more appropriate method for sampling less but informative data from Pavement ME simulations in developing high-dimensional ML surrogate models for the design of rigid pavement.

The remainder of this paper is structured as follows: Section 2 provided a review of the existing sampling methods that have been experimented with so far in developing surrogate ML models. In Section 3, a detailed description of the proposed sampling is presented, and its scalability is rigorously demonstrated. Section 4 applies the proposed technique to three well-known analytical functions, conducting a series of experiments to demonstrate the sampling process and verify its effectiveness. Furthermore, in Section 5, the efficacy of the approach is demonstrated in a real-world practical engineering design problem related to pavement design. A comprehensive sensitivity study is conducted to verify the accuracy and efficiency of the developed surrogate models using the proposed method and the explicit benefits to pavement design applications. Scalability has been demonstrated for this problem. In Section 6, the results are discussed and the application scenarios of the proposed method are highlighted. Finally, in Section 7, the conclusions are presented.

### 2. Sampling Techniques

Various approaches have been used to address the challenge of high-dimensional surrogate modeling in “one-shot” sampling. One such approach involves using dimensionality reduction techniques such as Principal Component Analysis (PCA), sensitivity analysis, and partitioning. However, these methods often yield parameters that are not physically interpretable or require prior knowledge to remove insignificant parameters, which may not be feasible in practical cases. Another common strategy is to use the adaptive sampling (or active learning) method. Adaptive sampling has emerged as a powerful tool in training ML models for constructing highly nonlinear surrogate models with relatively fewer computational simulations and training samples as compared to “one-shot” DoE. In such cases, adaptive sampling techniques can be used to optimize the training data set and reduce the number of required training samples.

### 2.1 Adaptive Sampling and Active Learning

Adaptive sampling is an Artificial Intelligence (AI) and ML algorithm that utilizes a semi-supervised approach to develop highly accurate data-driven models. It aims to train the model with the most informative data possible while using fewer samples. This method dynamically adds new training samples or data points based on certain criteria and information gained from the previous iterations. When adaptive sampling is used with the ML model, the model and its parameters are updated iteratively as new training samples are added or labeled. This iterative process results in more efficient use of data and can lead to better sample distributions compared to “one-shot” sampling methods. Ultimately, this results in accurate data-driven models with fewer training points, making adaptive sampling an attractive approach for surrogate modeling.

In the age of big data, it is commonly assumed that there is always enough data available for developing data-driven models in the field of AI and ML. Therefore, as a specific form of adaptive sampling, active learning is often used interchangeably with adaptive sampling. Active learning is generally applied when the data is readily available and abundant, but labeling the data is expensive. Most of the active learning methods, e.g., version space-based method, uncertainty sampling, and expected improvement (EI) algorithm, are usually applied to classification problems such as image recognition and natural language processing. Many surrogate modeling applications in engineering, on the other hand, are regression problems, where these existing methods cannot be used directly.

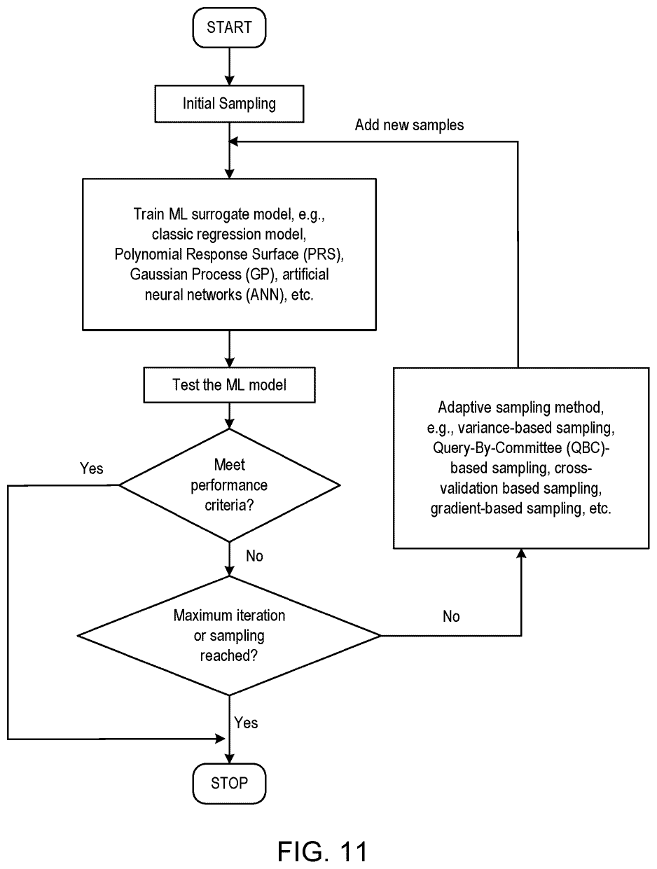

Pavement design is a high-dimensional engineering surrogate modeling problem where data is scarce for developing an accurate regression model, and obtaining data at selected points is computationally expensive and time-consuming due to the need for performing simulations using Pavement ME. Active learning is therefore not appropriate for direct use, and a novel adaptive sampling method with a focus on selecting the most informative or representative samples is needed. Several underlying adaptive sampling methods, such as variance-based adaptive sampling, Query-By-Committee (QBC)-based adaptive sampling, Cross-Validation (CV)-based adaptive sampling, and gradient-based adaptive sampling have been suggested in the literature. FIG. 11 shows a general surrogate modeling process utilizing adaptive sampling and ML. As shown, these adaptive sampling methods prioritize the sampling process for selecting new data to train and improve the performance of ML models with reduced computational costs.

### 2.2 “Curse of Dimensionality” in Adaptive Sampling

Even though adaptive sampling usually produces fewer and better-distributed samples than “one-shot” sampling, high-dimensional surrogate modeling remains a challenging task for most existing adaptive sampling methods due to the “curse of dimensionality.” There are two manifestations of the “curse of dimensionality” in adaptive sampling methods (a) the quantity of training samples necessary to build a dependable surrogate model becomes immense (this is similar to “one-shot” sampling), and (b) the difficulty in evaluating optimum new points for further iterations so as to reduce computational cost (especially in high-dimensional problems) while also maximizing the improvement in model accuracy.

The determination of new training samples in the context of adaptive sampling can happen either before or after the experiments or computational simulations at each iteration, i.e., the pre-selection process and the post-selection process, respectively. In the pre-selection process, the new training samples are determined before running the experiments or computational simulations. This selection is typically based on some criteria or measures derived from the existing training and testing data or the current state of the ML model. In the post-selection process, the experiments or computational simulations are run first for a set of unlabeled or untested candidate data points for obtaining target outputs (ground truth). The ML model is also employed to make predictions for these data points, with the predictions being compared with the target outputs to obtain the variance or uncertainty. Afterward, the candidate new samples with the highest variance or uncertainties are selected as the new training samples at the next iteration.

Most existing adaptive sampling methods, such as variance-based adaptive sampling and uncertainty sampling, usually apply a post-selection process to choose new training samples. All candidate data points are fed to experiments or computational simulations to acquire target outputs before the selection of new samples. This process, in turn, aggravates the “curse of dimensionality.” In addition, these adaptive sampling methods also rely on random sampling techniques to maximize the uncertainty in selected new training samples. However, the randomization of samples usually necessitates looping through all candidate points to acquire the new samples with the largest variance or uncertainty. This process also aggravates the “curse of dimensionality” in terms of extensive computations.

### 2.3 Limitations of Current Practice

While some existing adaptive sampling methods tried to mitigate the “curse of dimensionality” in high-dimensional surrogate modeling, these studies are either too problem-specific or computationally expensive to implement in this case because they need a post-selection of new training samples. Indeed, due to the limitations summarized above, no research has been conducted to apply adaptive sampling for developing high-dimensional surrogate models for pavement design.

Recall that running Pavement ME software is computationally expensive, and there is a great necessity for developing high-dimensional ML surrogate models for promoting and accelerating the M-E design of rigid pavements. As there is no existing adaptive sampling method appropriate to this application, we, therefore, developed a novel adaptive sampling method, named Scalable Adaptive Sampling (SAS) for developing accurate yet efficient surrogate models, minimizing the required number of Pavement ME simulations, and enabling a high-dimensional design optimization of rigid pavement. This present disclosure leveraged variance-based and uncertainty-based adaptive sampling methods and aimed to locate the area with higher uncertainty or variance and proceed to generate new informative samples in this area for training and updating the ML models. This approach achieves scalability by limiting the stochasticity of candidate training samples. Specifically, at each iteration, the ML model is tested at randomly sampled points, but new training points are only added from a full factorial DoE, where all candidate points are deterministic. The DoE training candidates are sampled from a relatively low but deterministic factorial level, and the factorial level increases deterministically with each iteration. By leveraging the deterministic nature of the candidate's new points, scalability can be achieved with the integration of the pre-selection process. To develop complex yet accurate surrogate models, this method is integrated with ML techniques that utilize Artificial Neural Networks (ANNs).

### 3. SAS: Scalable Adaptive Sampling

As previously noted, randomized adaptive sampling requires a post-selection process for determining the new training samples resulting in an exponential increase in sample size, extensive computations, and computational simulations in high-dimensional surrogate modeling. To address this challenge, a new adaptive sampling method is introduced, named Salable Adaptive Sampling (SAS) which is combined with ML to develop surrogate models for various problems. Suppose f(x) is a model that takes a set of inputs n∈ [symbol] and returns a value in [symbol] It is sought to develop an ML model f_{ML}(X)≈f(x) in the d dimensional inference space

$${U}_{i = 1}^{d} [ {a}_{i} , {b}_{i} ] .$$

Also, suppose [symbol] _{d}(n) represents the set of sample points in a full factorial DoE of level n∈ [symbol] , and Ω_{d} represents the set of all training data points for the ML model at any iteration, which is also represented by n.

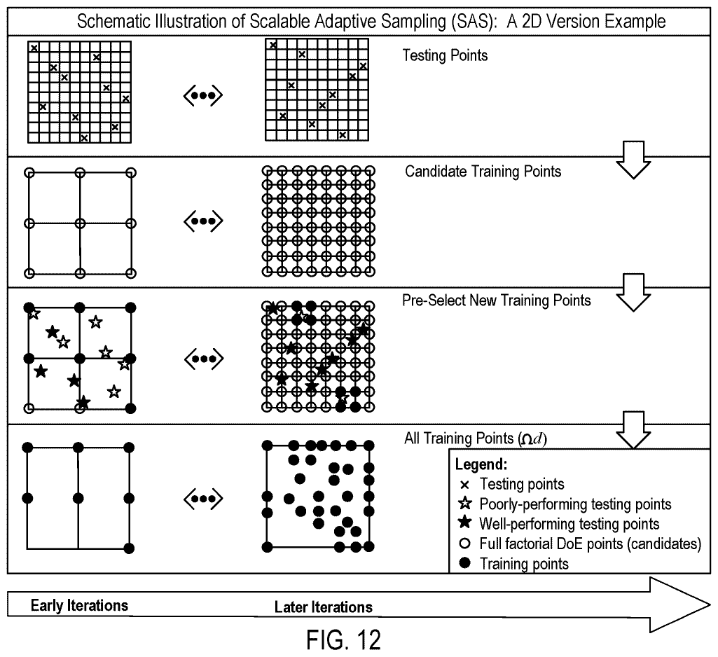

FIG. 12 provides a schematic overview of the proposed method using a 2D version example. At each iteration, testing samples may be generated using a random sampling method, such as Latin Hypercube Sampling (LHS), and apply them to test the ML surrogate model derived from the previous iteration. However, a candidate pool for training points is generated using a full factorial DoE, which is deterministic. The resolution of the full factorial DoE mesh points increases with each iteration, leading to a progressively larger but always deterministic candidate pool. Next, new training points may be selected from this candidate pool using the information obtained from each testing point at each iteration, e.g., variance or uncertainty. Finally, the new training points may be used to perform computational simulations or experiments for target outputs, which are used to train and update the ML surrogate model. This process is repeated iteratively until certain criteria or measures fall below the specified tolerance. As shown in FIG. 12, the candidate points have a relatively coarse resolution at early iterations, with the resolution becoming finer at later iterations.

While there are many variations of the general process described above, Algorithm 1 details a particular implementation in this study. The algorithm begins at n=1, in which the training dataset is bootstrapped with all the factorial points in an n+1 (=2) level full factorial DoE, [symbol] _{d}(2). At each iteration n, the ML model is trained using any suitable training algorithm. Then, a set Γ of testing points is sampled randomly from the inference space using the LHS technique and tested on the surrogate model. If the mean squared error (MSE) (or any other suitable measure of accuracy) of the testing points is less than a predefined tolerance ∈, then the model is deemed to have converged, and the algorithm terminates. However, if the MSE tolerance is not met, the algorithm may find all the testing points, whose variance (i.e., SE) is higher than the MSE threshold. Therefore, their specific spatial position and the adjacent area are deemed as the highly-nonlinear area or the area the proposed f_{ML} has poor performance. In this case, more training points are expected to be added in this area. To do so, for each poorly performing testing point γ in Γ, a set of new training points a is added to the training dataset. This process is repeated until convergence, or until a maximum number of iterations. Generally, any appropriate sampling technique S(γ) maybe applied for determination of ∂ using the information gained from local or global exploitation, although the choice of S(γ) is key for scalability.

```
Algorithm 1 The proposed algorithm (pseudo-code) for developing a
surrogate ML model
Input: Set Ω_{d} = φ; Iteration number n = 1; Tolerance = ε
While n < maximum iterations:
  If n == 1 then:
    Get full factorial training points [symbol]  _{d} (n + 1) and f( [symbol] _{d} (n + 1))
    Set Ω_{d} = [symbol]  _{d} (n + 1) ∪ Ω_{d}
  Else:
    Train an ML model f_{ML} over Ω_{d}
    Get testing points Γ and f(Γ), f_{ML}(Γ)
    $If \frac{1}{\vert Γ \vert} {‖ f ( Γ ) - {f}_{M L} ( Γ ) ‖}_{2}^{2} \leq ε then :$
      Break
    Else:
      For each γ ∈ Γ:
        $If {‖ f ( γ ) - {f}_{ML} ( γ ) ‖}_{2}^{2} > ε then :$
          Get ∂ = S(γ) and f(∂)
          Set Ω_{d} = Ω_{d} ∪ ∂
        End If
      End For
    End If
  End If
  Set n = n + 1
End While
Return f_{ML}
```

From Algorithm 1, it can be seen that with each iteration n, the algorithm scales linearly as O(n). The scalability with the number of dimensions, d, depending on the scalability of S(γ). If it is defined that S(γ)≡γ, which is a random sampling method, then the scaling becomes exponential as O(|Γ|^{d}). Therefore, a function S(γ) which scales better than O(|Γ|^{d}) is sought.

A function

$$S ( γ ) ≡ {NNS}_{k}^{d} ( γ , n + 1 )$$

is proposed, whose algorithm is shown in Algorithm 2 below, named as k-Nearest Neighbor Search (k-NNS). It should be noted that k-NNS is different from the well-known k-nearest neighbor (kNN) clustering algorithm, which is normally applied for classification problems in ML. The motivation for this function (k-NNS) is, for each testing point γ, to add the k nearest neighbors around γ that belong to the next (n+1) level factorial from a full factorial [symbol] _{d}(n+1). Thus, while the testing points are randomized for maximizing the uncertainty, the set of new training points ∂ are selected from a candidate pool that is deterministic and can be determined efficiently, which allows for reducing the number of required computations in selecting new training points and computational simulations or experiments to obtain target outputs and thus improving scalability. Benefiting from the deterministic candidate training points in SAS (Algorithm 1), the novel k-NNS can pre-select the most informative candidate new training points in each dimension of the high-dimensional inference space as inspired by the coordinate-wise k-NNS or axis-parallel k-NNS approaches.

### Algorithm 2 Nearest Neighbor Search

$$( {NNS}_{k}^{d} ( γ , n ) )$$

### Algorithm (Pseudo-Code)

```
$Algorithm 2 Nearlest neighbor ( NN \frac{d}{k} ( γ , n ) ) algorithm ( pseudo - code )$
Input: Set a sufficiently large search width SW ∈ [symbol]  , inference space
dimension = d, factorial level = n, number of nearest neighbors =
k ≤ (2SW)^{d}
For i = 1 to d:
  $Define d {ω}_{i} = ( \frac{{b}_{i} - {a}_{i}}{n - 1} )$
  Define γᵢ = γ · êᵢ
  $Get {η}_{i} := floor ( \frac{{γ}_{i} - {a}_{i}}{d {w}_{i}} )$
  $Define {N}_{i}^{-} := {⋃}_{j = 0}^{S W - 1} [ {a}_{i} + ( {η}_{i} - j ) d {ω}_{i} ] , ( {η}_{i} - j ) \geq 0$
  $Define {N}_{i}^{+} := {⋃}_{j = 0}^{S W - 1} [ {a}_{i} + ( {η}_{i} + j + 1 ) d {ω}_{i} ] , ( {η}_{i} + j + 1 ) \leq n$
  $Ni = {N}_{i}^{-} ⋃ {N}_{i}^{+}$
End For
Define N = N₁ × N₂ × N₃ × . . . × N_{d}, |N| ≤ (2SW)^{d}
Define ρ = φ
For i = 1 to k then:
  $Set ρ = ρ ⋃ {arg min}_{N} {‖ N - γ ‖}_{2}$
  Set N = N\ρ
    If N = φ then:
      Break
    End If
End For
Return ρ
```

As shown in Algorithm 2, the main parameter of the proposed function is the search width SW, which can be predefined by the user. The algorithm proceeds as follows. For each dimension i, the algorithm loops through one dimension at a time. In each dimension, dwᵢ represents the size of the interval of that dimension in the factorial set [symbol] _{d} (n) and is evaluated first. Recall that

$$S ( γ ) ≡ {NNS}_{k}^{d} ( γ , n + 1 ) ,$$

and so the function may actually be called at the next (n+1) level factorial [symbol] _{d} (n=1) as the iteration number n in Algorithm 1; the following discussion, however, is for any n passed as an argument to

$${NNS}_{k}^{d} ( γ , n ) .$$

Next, the variable nᵢ is the ordinal number of the nearest point just before the projection of the testing point γ·êᵢ in the n level factorial and is evaluated efficiently through an O(1) operation. Then, for a given SW, dwᵢ and nᵢ are used to efficiently generate a set of points that are within SW in both negative

$${N}_{i}^{-}$$

and positive

$${N}_{i}^{+}$$

directions and also within the bounds of the inference space aᵢ, bᵢ. SW thus determines the total number of candidate points in each dimension.

All the sets of points in each dimension Nᵢ are then meshed to constitute the candidate pool N for the new training samples for each testing point γ. The total number of such points is shown to be (2SW)^{d} and they are always a subset of [symbol] _{d} (n). The last step of the algorithm is to obtain the k nearest neighbors (in terms of Euclidean distance) ρ to each testing point γ from the candidate pool N, which requires at most k evaluations. While k is a user-specified input to the function, it is bound by k≤(2SW)^{d}. A value of 1 or 2 for SW and k<<(2SW)^{d} for a reasonably large d are also usually sufficient. The function finally returns the set of new training points ρ, and Algorithm 1 proceeds as discussed previously. It should be noted that, as shown in Algorithm 1, only the finally selected new training points ρ may be used as inputs to obtain the target outputs f(ρ) by performing necessary computational simulations or experiments.

Considering the scalability of Algorithm 2, it can be shown to scale as O((2SW)^{d}), primarily from the Euclidean distance evaluation. Therefore, when Algorithm 1 and 2 are used together, the proposed adaptive sampling technique scales as O(n(2SW)^{d} as compared to a typical randomized adaptive sampling technique, which scales as O(n|Γ|)). Typically, 2SW is a small, constant value compared to |Γ|, i.e.,

$$\frac{2 SW}{\vert Γ \vert} << 1 ,$$

and so the proposed technique scales much better than typical randomized adaptive sampling with the dimensionality of the inference space. Furthermore, it also scales much better than a “one-shot” DoE approach, which scales as O(n^{d}).
Experiments with Benchmark Functions

The methodology illustrated above was first applied to several benchmark examples to demonstrate its effectiveness. Three illustrative examples, Shekel Function, Peak Function, and Ackley Function, were applied in the inference spaces [0,10]2, [−3,3]2, and [−2,2]2, respectively. The proposed method was used to train ANN models for each of these functions. The results are discussed below.

### 3.1 Shekel Function

For the first numerical experiment, a typical 2D version of the Shekel Function may be used with a global minimum presented in the middle of the 2D space. FIG. 2 displays the analytical response surface, which reveals that the Shekel Function has a sharp minimum of −10.54 at the point (4,4). Apart from this minimum and the region surrounding it, the function is relatively flat.

The proposed method is implemented, and neural networks are used for surrogate modeling using the open-source software library TensorFlow. Table 1 summarizes the settings and hyperparameters used for both the proposed sampling algorithm and the neural networks. Note that, since the proposed technique still employs random sampling for the testing points, 10 ensemble runs may be performed for each ANN model to eliminate any bias caused by the random sampling. These 10 ANN models serve as ensemble models for computing the QBC-based variance that improves the local exploitation in the proposed SAS process.

TABLE 1
Settings of hyperparameters for the proposed
algorithm and neural networks

| Settings | Hyperparameters | Values |
|---|---|---|
| Proposed | Inference space dimension (d) | 2 |
| Sampling | Number of LHS test points at | 20 |
| Method | each iteration (\|Γ\|) | |
| | Search width (SW) | 2 |
| | Number of nearest neighbors | 3 |
| | (k) | |
| | Tolerance (∈) | 10⁻³ |
| | Max iteration number | 50 |
| Neural | Architecture | 2 hidden layers, with 10 |
| Networks | | neurons in each layer |
| | Activation function | Hyperbolic tangent (tanh) |
| | Optimizer | Adam |
| | Loss function | Mean Squared Error (MSE) |
| | Number of ensemble models | 10 |

FIGS. 3(A)-(D) depicts the distribution of training and testing samples, the ensemble mean predictions, and response surfaces predicted by the ensemble ANN model for increasing iterations of the algorithm. The comparison between the analytical solution and ensemble mean predictions along the line X₂=4 is also shown. The predicted response surface is initially quite different from the analytical solution, but the accuracy improves significantly as the algorithm progresses.

To evaluate the performance of the models, the prediction accuracy is assessed at the minimum at point (4,4) to show local performance and accuracy at points in the relatively flat area to show global performance. The local performance was quantified by comparing the minimum predicted value with the analytical value, −10.54. The global performance was measured by computing the ensemble mean MSE of the testing points. The proposed method achieved high accuracy in both local and global performance measures.

As shown in FIGS. 3(A) and (B), at early iterations, the training samples are relatively sparse in the given 2D space, and the sample size increases slowly. At later iterations, as shown in FIGS. 3(C) and (D), the new training points are sampled from a finer mesh, with a relatively larger increase in sample size as compared to the early iterations. The ensemble mean MSE decreases with each iteration, indicating an improving global performance of the ANN models. At iteration 11 (FIG. 3(D)), the MSE reaches 4.0×10\hat{ }(−4), reflecting convergence. At early iterations (FIGS. 3(A) and (B)), the ANN models predict a minimum of −0.18 and −1.37 at point (4,4) at iterations 1 and 4, respectively, which have a relatively large error as compared to the analytical value of −10.54. In addition, the ANN model predictions along X₂=4 are relatively flat at these early iterations. However, from iterations 4 to 8 (FIGS. 3(A) and (C)), the predicted minimum value improves significantly from −1.37 to −10.45, where the surrounding nonlinear behavior was captured by the ANN model predictions. Finally, the predicted minimum value reaches −10.47, at iteration 11 (FIG. 3(d)), with more consistent predictions with the analytical solution in the surrounding area. It can be concluded that the ANN models developed using the proposed method perform well both locally and globally for the Shekel Function.

### 3.2 Peak Function

FIG. 4 illustrates the surface of the Peak Function's analytical solution, which exhibits several local extrema and relatively flat regions in between. This function is more nonlinear compared to the Shekel Function. In order to create surrogate models for the Peak Function, the proposed method is used to train 10 ensemble ANN models that served as QBC with the same settings outlined in Table 1. To assess the global accuracy of these ANN models, the ensemble mean MSE of the space-filling testing points is calculated at each iteration. The local performance may be qualitatively evaluated by analyzing how and when the ANN predictions captured the local extrema, in comparison to the analytical solution presented in FIG. 4.

FIGS. 5(A)-(D) visualize the corresponding sampling distributions, the comparison between the analytical solution and ensemble mean predictions along the line X₁=0, as well as predicted response surfaces for increasing iterations. It can be observed from FIGS. 5(A) and (B) that the ensemble mean MSE has improved significantly, showing that the algorithm prioritizes global performance at early iterations. The responses of ANN predictions at iteration 4 also show a visible improvement from iteration 1, with multiple local extrema beginning to appear. At iteration 8 (FIG. 5(C)), the MSE was significantly improved, from 7.0×10⁻² (iteration 4) to 3.4×10⁻³, with only 114 training points being added. In addition, the neural networks captured all the peaks and valleys and the surrounding transition areas, showing that the algorithm is able to find local extrema. The difference between iteration 11 (FIG. 5(D)) and iteration 8 is relatively small in terms of the local extrema, but the MSE was improved from 3.4×10⁻³ to 9.5×10⁻⁴, indicating convergence, with only 225 well-distributed training samples. The final training samples are distributed tightly around the extrema and sparsely in between. This confirms the efficiency and effectiveness of the proposed method in surrogate modeling of the Peak Function.

### 3.3 Ackley Function

Finally, a 2D version of the Ackley Function may be considered to develop a surrogate model. FIG. 6 represents the response surface, which has the largest number of local extrema and is the most complex of the three functions due to its more oscillatory and highly nonlinear behavior. 10 ensemble ANN models serving as QBC and utilizing the same setting parameters as other functions (Table 1) were trained and updated iteratively using the proposed method. In this case, the global performance may be looked at in terms of the ensemble mean MSE.

FIGS. 7(A)-(D) show the sample distribution, the comparison between the analytical solution and ensemble mean predictions along the line X₂=0, and the predicted response surfaces at representative iterations, from the top to the bottom. As shown in FIG. 7(A), only 4 training points were applied for surrogate modeling at iteration 1, resulting in a flat prediction surface with an ensemble mean MSE of 8.3. Starting from the 9th iteration (FIG. 7(B)), the ANN models start to capture the nonlinear behavior but are still not able to resolve the local extrema with 219 training samples. The ensemble mean MSE was improved to 2.2×10⁻². At the 17th iteration (FIG. 7(C)), the improved distribution of 581 training samples enables full capture of all the local extrema, with the ensemble mean MSE decreased to 2.2×10⁻³. Finally, with 212 new training samples being added, the MSE was 8.8×10⁻⁴ at iteration 25, indicating convergence. Compared to the surrogate modeling of the Shekel Function (FIG. 2) and Peak Function (FIG. 4), both the iteration number meeting convergency and corresponding training points of the Ackley Function are much higher than the other two, due to the highly nonlinear behavior.

Based on the results, it can be concluded that the proposed new technique can effectively capture nonlinearity in low-dimensional benchmark problems. The technique adaptively samples different well-distributed training points for each problem without any prior knowledge of the solution. In the following section, the application of this method is discussed to a practical engineering pavement design problem and demonstrate its scalability with respect to dimensionality.

### 4. Pavement Design Applications

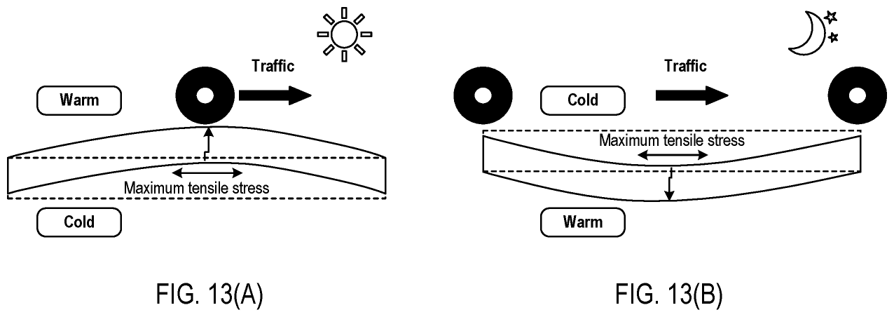

In this section, the application of the proposed SAS method to develop surrogate models for the design of rigid pavements is presented. The selection of an appropriate concrete slab thickness requires the designer to ensure that the anticipated fatigue cracking at the end of the design life remains below the specified threshold. Fatigue cracking in concrete slabs can initiate either from the bottom and propagate upward or from the top and propagate downward. During the daytime, when the top surface is warmer than the bottom surface, as shown in FIG. 13(A), the concrete slab curls upwards, creating favorable conditions for bottom-up cracking. Conversely, during the night, the slab curls downwards due to the bottom surface being warmer than the top (see FIG. 13(B)) leading to favorable conditions for top-down fatigue cracking. To account for these effects, Pavement ME computes fatigue damage at the top and bottom surfaces of the concrete pavement, respectively. Fatigue damage is a unitless measure of cracking performance used in a design. For a single concrete slab, fatigue damage close to zero indicates good performance, while over one indicates failure in fracture mechanics.

For a project-level pavement design, the percentage of cracked slabs over a large number of individual concrete slabs is estimated for evaluation of long-term pavement performance. In this case, the top and bottom surface damages are usually used to predict the occurrence of bottom-up and top-down cracking, respectively, using the calibrated cracking model and then computes the total amount of cracking by considering these quantities:

$${CR}_{TD or BU} = \frac{100 \%}{1 + {C}_{1} {DAM}_{T or B}^{{C}_{2}}}$$

Where CR_{TD or BU} represents the percentage of top-down or bottom-up cracked slabs, respectively. DAM_{T or B} denotes top surface or bottom surface fatigue damage, respectively, C₁ and C₂ are calibration coefficients determined by local climate and environmental conditions.

Finally, the total amount of cracking over a large amount of concrete slab, CRₜₒₜ, is computed using the following equation:

$${CR}_{tot} = {CR}_{TD} = {CR}_{BU} - {CR}_{TD} \cdot {CR}_{BU}$$

To compute either top-down or bottom-up damage, the MEPDG requires performing thousands of FEA simulations to predict critical concrete tensile stresses for various combinations of axle weights, axle positions, temperature gradients, and other parameters. These stresses are then used for computing fatigue damage, which in turn is analytically related to the amount of cracking through a calibrated empirical model (Equations (1) and (2)). To improve computation efficiency, Pavement ME software implementing MEPDG employs neural networks to predict concrete stresses. These speed up the analysis process significantly, but further improvement in computational efficiency is still warranted.

The potential of the proposed SAS method is demonstrated herein by documenting the creation of a high-dimensional surrogate model for bottom-up fatigue damage. In a similar manner, the top-down fatigue damage model can develop. Six variables that have been demonstrated to have a significant impact on pavement damage may be selected: PCC elastic modulus (Epcc), PCC flexural strength often called modulus of rupture (MR), PCC coefficient of thermal expansion (COTE), traffic load magnitude, pavement thickness, and joint spacing. Initially, a 4D inference space was considered to validate the accuracy of the model generated by this approach. Later, the dimensionality of the inference space is increased to demonstrate scalability compared to the current “one-shot” classical DoE approach. Although the six variables were adequate for this research, the method can be expanded to include more variables.

### 4.1 Initial Model

To begin, a 4D inference space including COTE, MR, Epcc, and traffic load is constructed while keeping all other input values in the model fixed at typical values utilized in rigid pavement design. For example, the PCC slab thickness was assumed to be 225 mm under 1000 axle load repetitions per day for a 40-year design consideration. The response of the model was evaluated using Pavement ME within this 4D inference space. Ten ensemble neural networks were trained with an identical architecture as the instances presented in Table 1 for the implementation of QBC-enhanced SAS. This architecture consisted of four independent input variables, two hidden layers with 10 neurons each, and a single output layer with fatigue damage as the sole response variable. The 4D inference space is presented in Table 2. Since no adaptive sampling methods have been implemented for pavement design surrogate modeling in previous studies, to assess the performance of these neural networks relative to a “one-shot” approach utilized in prior research, several neural networks may be trained with 10-fold cross-validation using “one-shot” training at various levels of full factorial DoE (ranging from 2 to 7-level) with the same architecture.

TABLE 2
The inference space and design variables with corresponding
lower and upper bounds for the given 4-dimensional case study

| | PCC coefficient | PCC | PCC | |
|---|---|---|---|---|
| | of thermal | modulus | elastic | |
| Inference | expansion | of rup- | mod- | |
| Space | (10 − 6° C. − 1) | ture(MPa) | ulus(MPa) | Load(kN) |
| Lower Limit | 7.2 | 3.45 | 20700 | 35.6 |
| Upper Limit | 10.8 | 6.21 | 41400 | 178 |

The performance of the ANN models and the “one-shot” full factorial DoE ones was compared by evaluating their mean squared error (MSE) (or variance) on two independent benchmark datasets: a sample of 100 samples obtained using LHS random spacing-filling sampling, and an 8-level full factorial DoE (4096 samples). FIGS. 8(A) and (B) show the MSE for the two benchmark datasets, respectively. Both datasets show a decrease in MSE and improved model performance as the sample size increases. However, the neural networks trained using the proposed method outperform (by approximately an order of magnitude) those obtained using the “one-shot” full factorial DoE for the same number of training samples. For the same MSE, the proposed method requires only a fraction of training samples, with a 60% reduction in the required sample size for a mean MSE of 10⁻⁵ and a 70% reduction for 4×10⁻⁶. It can be concluded that for the given 4D inference space, the proposed method can effectively achieve significantly better performance with a similar training sample size or substantially reduce the training sample size without sacrificing prediction accuracy compared to the “one-shot” approach.

Sensitivity analyses were conducted over each of the four input variables for the neural networks developed using the proposed method to ensure that the predictions did not exhibit any non-physical behavior. The neural networks that developed with 500 SAS points were used for these analyses. The analyses were performed by varying one parameter at a time while keeping the other parameters constant in the middle of the inference space. FIGS. 9(A)-(D) display the results from the analysis for COTE, MR, Epcc, and load, respectively. Within the inference space, the fatigue damage increased with COTE, Epcc, and load, and decreased with MR, which is consistent with the expected behavior of the pavement. Several Pavement ME runs were also conducted and shown in FIGS. 9(A)-(D) as additional validation, and all of them showed good agreement with the neural network model predictions. It can thus be concluded that the surrogate model developed using the proposed method was accurate and could capture the underlying behavior of the system while requiring fewer sample points than other approaches.

As indicated previously, the total pavement fatigue damage at the end of the 40-year design life is a significant pavement performance criterion that was designed against using the MEPDG rigid pavement design. FIGS. 9(A)-(D)21 can therefore offer a comprehensive range of information applicable to pavement design for individual concrete slabs. It can be seen from FIGS. 9(A) and (C) that no matter how COTE and Epcc vary, respectively, in the given situation, the proposed design meets the fatigue damage failure criterion, a numerical value of 10⁰=1. However, in terms of MR and axle load, as shown in FIGS. 9(B) and (D), respectively, the MR below 3.9 MPa or axle load above 140 kN are considered inappropriate designs because the level of fatigue damage surpasses the failure criterion. The detailed process of using the fatigue damage surrogate models approaching a project-level concrete slab thickness optimization can be found elsewhere.

### 4.2 Higher-Dimensional Pavement Design Models

Another study was performed to demonstrate the scalability of the proposed method in higher-dimensional inference spaces as compared to the full factorial DoE. In this case, the inference space varied from 2D to 6D, as summarized in Table 3. Again, for each of these inference spaces, 10 ensemble neural network models serving as QBC with the same architecture as before were trained using the proposed method. Additionally, another set of neural networks was trained with “one-shot” 5-level full factorial DoE from 2D to 6D and 10-fold cross-validation. To compare the performance of these two approaches, several benchmark testing datasets were generated using the LHS method. The testing datasets represented fractions of the 5-level full factorial DoE from 2D to 6D, specifically 40%, 15%, 10%, 10%, and 10%, respectively. Correspondingly, the testing sample sizes for these datasets were 10, 20, 60, 300, and 1500, respectively.

TABLE 3
The inference space and design variables with corresponding lower
and upper limits or fixed values for the given 2D-6D case study

| | | | | PCC | | | |
|---|---|---|---|---|---|---|---|
| | | PCC | | coefficient | | | |
| | | modulus | PCC | of thermal | | | |
| | | of | elastic | expansion | | PCC | Joint |
| | | rupture | modulus | (10−6° | Load | thickness | spacing |
| Inference Space | | (MPa) | (MPa) | C.−1) | (kN) | (mm) | (m) |
| Lower Limit | | 3.45 | 20700 | 7.2 | 35.6 | 150 | 3.65 |
| Upper Limit | | 6.21 | 41400 | 10.8 | 178 | 400 | 6.10 |
| Dimensionality | 2D | varied | varied | 9.0 | 106.8 | 275 | 4.88 |
| | 3D | varied | varied | varied | 106.8 | 275 | 4.88 |
| | 4D | varied | varied | varied | varied | 275 | 4.88 |
| | 5D | varied | varied | varied | varied | varied | 4.88 |
| | 6D | varied | varied | varied | varied | varied | varied |

FIG. 10(A) displays the MSE distribution (over cross-validations and ensembles) obtained from benchmark testing datasets using neural network predictions generated by the “one-shot” full factorial DoE and the proposed method. The results show that the MSE between the two methods is comparable across all inference spaces, with the models developed with the proposed method performing slightly better. FIG. 10(B) illustrates the corresponding sample sizes and their ratio between the proposed method and the “one-shot” approach. It can be observed that the full factorial DoE's sample size exponentially increases with the inference space's dimensionality. In contrast, the proposed method's sample size increases slowly while maintaining comparable performance. For instance, for low-dimensional spaces (e.g., 2D)), the proposed method results in a larger sample size than a full factorial DoE. However, for higher dimensions (3D and above), the sample size ratio decreases significantly with respect to dimensionality, reaching as low as 5% for a 6D inference space. These findings confirm the scalability analysis discussed earlier in the paper and demonstrate that the proposed SAS method can be leveraged to develop accurate surrogate models in high-dimensional pavement design applications while significantly reducing the required sample size compared to the “one-shot” full factorial DoE approach.

### 5. Discussion

In engineering applications of AI and ML, such as ML-based pavement design, high-dimensional surrogate modeling remains a challenge due to the “curse of dimensionality,” which makes “one-shot” sampling and most existing adaptive sampling methods computationally expensive. The existing adaptive sampling methods often require looping through all candidate points for the post-selection of new training points at each iteration, making them infeasible in high-dimensional inference spaces. To address this issue, an adaptive sampling method is developed, named Scalable Adaptive Sampling (SAS) that mitigates the “curse of dimensionality” in three ways: (a) reducing the training sample size for developing an accurate ML surrogate model as compared to “one-shot” sampling; (b) reducing the number of required computational simulations for obtaining target outputs in determining new training samples using a pre-selection process; and (c) minimizing the computational burden of selecting new training samples using the deterministic properties of candidate training points.

A deterministic DoE sampling method is used, specifically the full factorial DoE, for generating candidate points in the given d-dimensional inference space. The spatial location or coordinate of each candidate point was extracted and utilized to generate new candidate training points at each iteration using Algorithm 1. The candidate training points, along with the novel k-NNS algorithm (Algorithm 2), were applied to pre-select new training points for the next iteration. Only these pre-selected new training points were extracted to obtain target outputs from computational simulations for training and updating ML models at the next iteration. This combination effectively minimizes the number of required computational simulations and computations in selecting new training points and obtaining target outputs, resulting in better scalability than randomized adaptive sampling methods. Additionally, the proposed method has better scalability than the “one-shot” DoE method with respect to sample size in high-dimensional surrogate modeling, as demonstrated in FIG. 10(B).

It is worth noting that the proposed method still requires an exponential increase in training samples with dimensionality. As shown in FIG. 10(B), the required sample size approximately doubles with each additional dimension. Moreover, it should be noted that implementing the proposed method requires practitioners to have control over when and how to sample data points in the given inference space and have the ability to perform computational simulations or experiments to obtain target outputs. The SAS is not necessarily the best method for mitigating the “curse of dimensionality” among adaptive sampling methods. However, SAS is the most suitable approach for us to address the “curse of dimensionality” in high-dimensional surrogate modeling of pavement design among those reported in the literature. SAS also has a great potential for surrogate modeling applications in scientific or other engineering problems, serving as a replacement for expensive experiments or computational simulations.

### 6. Conclusions

Surrogate modeling is an effective way to approximate high-fidelity computational simulations, e.g., mechanistic-empirical pavement design applications. However, when it comes to high-dimensional inference spaces, the “curse of dimensionality” makes them computationally expensive due to the exponentially increasing sample size needed with each additional dimension. To address this issue, an adaptive sampling method is used, named Scalable Adaptive Sampling (SAS), that is scalable for high-dimensional inference spaces in pavement design applications. This method utilizes a deterministic full factorial design of experiment (DoE) to generate candidate pools for pre-selecting new training samples before performing computational simulations. This approach enables an efficient algorithm that scales better with the dimensionality of the problem compared to existing randomized adaptive sampling techniques and “one-shot” sampling. In this implementation of the method, random sampling is iteratively applied for the generation of testing samples to evaluate the developed surrogate models, locate areas with higher uncertainty or variance, and collect more informative new training samples. It should be noted that the proposed method requires the practitioner to have control over when and how to sample the data in the given inference space and to be able to perform computational simulations or experiments to obtain the target outputs.

Several benchmark experiments with analytical solutions were used to demonstrate the effectiveness of the proposed method. The results show that the proposed method can effectively navigate regions with high local nonlinearity while providing satisfactory overall global performance in an efficient manner. Furthermore, the proposed algorithm was applied to surrogate modeling in practical civil engineering pavement design case studies, which confirmed its effectiveness in higher-dimensional inference spaces. Compared to a “one-shot” factorial DoE sampling, the surrogate models derived from the proposed sampling method performed better with a similar sample size or required only a small fraction of the sample size to achieve the same performance. For a 14D inference space, the surrogate models derived from the proposed method had an order of magnitude smaller error than the “one-shot” factorial DoE with the same sample size. Additionally, for comparable performance, the proposed method required only 30% to 40% of the sample points compared to a full factorial DoE. The developed neural network models allowed for fast evaluations of pavement design and facilitated optimization of pavement design in high-dimensional spaces, which is infeasible in current Pavement ME software. Furthermore, the sample size required by the proposed method increased slowly with dimensionality, requiring only about 5% of the number of samples needed by a “one-shot” full factorial DoE in a 6D inference space.

### C. Systems and Methods of Training Machine Learning Models Using Surrogate Model Techniques

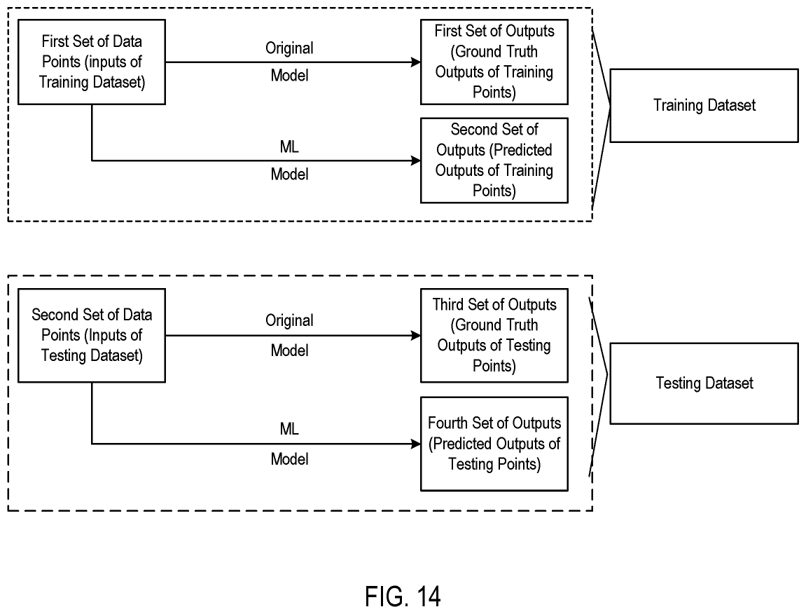

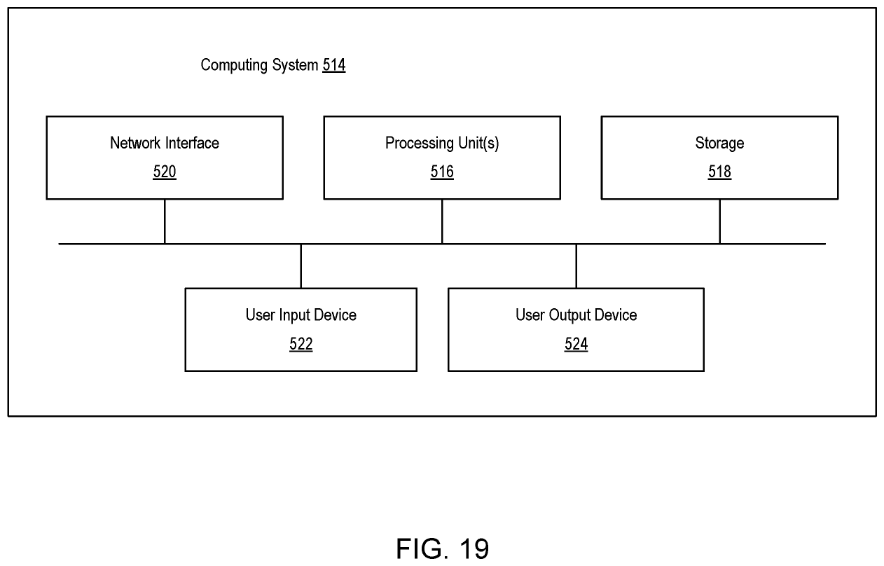

Referring now to FIG. 14, depicted is a block diagram of constituent data points for training datasets and testing datasets to be used in training machine learning (ML) models. The data points may be stored and maintained using memory coupled with one or more processors of a computing system detailed herein in conjunction with FIG. 19. The training dataset may include a first set of data points corresponding to inputs and may be defined in a feature space using a pattern (e.g., a mesh or grid within the feature space). The training dataset may include a first set of outputs corresponding to ground truth output generated using an original model (sometimes herein referred to as a function). The training dataset may include a second set of outputs corresponding to predicted outputs generated using a machine learning (ML) model.

In addition, the testing dataset may be generated at each epoch for training the ML model. The testing dataset may include a second set of data points corresponding to inputs and may be defined in the feature space. The second set of data points may be generated at random at each training epoch. The testing dataset may include a third set of outputs corresponding to ground truth output generated using an original model (or the function). The testing dataset may include a fourth set of outputs corresponding to predicted outputs generated using the ML model.

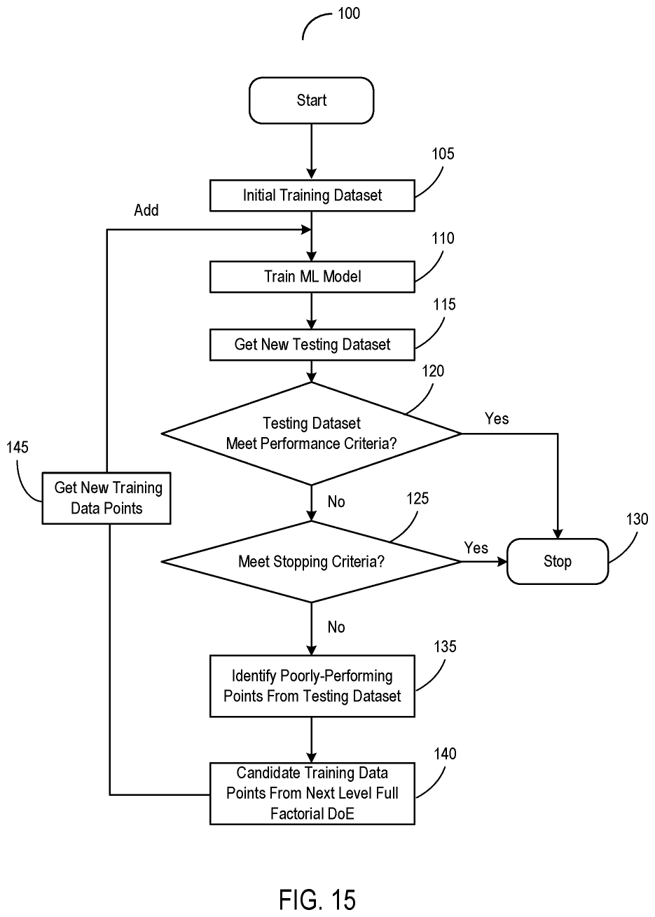

Referring now to FIG. 15, depicted is a flow diagram of a process 100 for training machine learning (ML) models. The process 100 may be implemented using or performed by one or more processors of a computing system detailed herein in conjunction with FIG. 19. Under the process 100, a computing system may identify an initial training dataset (105). The computing system may train a machine learning (ML) model using the training dataset (110). The computing system may generate a new testing dataset including the inputs and outputs (115). The computing system may determine whether the testing dataset satisfy performance criteria (120).

If the testing dataset is determined to not satisfy the performance criteria, the computing system may determine whether a stopping criteria is met (125). If the stopping criteria is met or the testing dataset satisfies the performance criteria, the computing system may stop the training (130). When the stopping criteria is not met, the computing system may identify poorly-performing points from the testing dataset (135). The computing system may select candidate training data points from next level full factorial design of experiment (DoE) (140). The computing system may obtain new training data points (145).

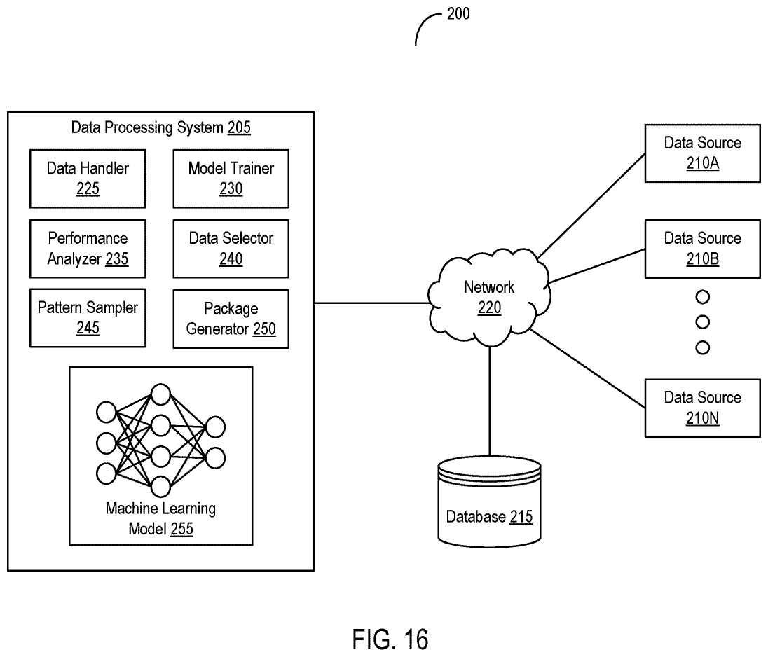

Referring now to FIG. 16, depicted is a block diagram of a system 200 for training machine learning (ML) models using surrogate modeling. In overview, the system 200 may include at least one data processing system 205, one or more data sources 210A-N (hereinafter generally referred to as data sources 210), and at least one database 215. The data processing system 205, the data sources 210, and the database 215 may be communicatively coupled with at least one network 220. The data processing system 205 may include at least one data handler 225, at least one model trainer 230, at least one performance analyzer 235, at least one data selector 240, at least one pattern sampler 245, and at least one package generator 250, and at least one machine learning (ML) model 255, among others. Each of the components in the system 200 as detailed herein, may be implemented using hardware (e.g., one or more processors coupled with memory), or a combination of hardware and software as detailed herein in Section D. The system 200 may implement or perform the functionalities detailed herein in Sections A and B.

In further detail, the data processing system 205 may (sometimes herein generally referred to as a computing system or a server) be any computing device including one or more processors coupled with memory and software and capable of performing the various processes and tasks described herein. The data processing system 205 may be in communication with the data sources 210 and the database 215 via the network 220. The data processing system 205 may be situated, located, or otherwise associated with at least one server group. The server group may correspond to a data center, a branch office, or a site at which one or more servers corresponding to the data processing system 205 are situated.

Within the data processing system 205, the data handler 225 may identify datasets including data points to be provided to the ML model 255. The model trainer 230 may manage the establishment and training of the ML model 255. The performance analyzer 235 may evaluate the performance of the ML model 255 and individual data points. The data selector 240 may select data points based on the performance. The pattern sampler 245 may output additional data points using the selected data points. The package generator 250 may generate a dataset to be used to retrain the ML model 255.

The ML model 255 may be any type of artificial intelligence (AI) algorithm or model, such as an artificial neural network (ANN) (e.g., convolutional neural network (CNN) or transformer), a regression model (e.g., linear or logistic), a support vector machine (SVM), random forests, a Bayes network, or a clustering model (e.g., k-means clustering), among others. In general, the ML model 255 may have a set of inputs and a set of outputs. The ML model 255 may include a set of weights in accordance with the architecture of the algorithm. The set of weights may represent, define, or otherwise correspond to a relationship between the inputs and outputs of the ML model 255. The ML model 255 may be initialized, trained, and established in accordance with surrogate modeling techniques.

The data source 210 may be any computing device comprising one or more processors coupled with memory and software and capable of performing the various processes and tasks described herein. The data source 210 may be in communication with the data processing system 205 and the database 215 via the network 220. The data source 210 may be a smartphone, other mobile phone, tablet computer, wearable computing device (e.g., smart watch, eyeglasses), or laptop computer. The data source 210 may generate or provide datasets with which to train the ML model 255. In general, the dataset may include a set of inputs and a set of outputs of a function (e.g., a system). The inputs may correspond to different variables. The outputs may correspond to the response of the function. The datasets may be acquired by the data source 210 using sensors and instrumentation.

The database 215 may store and maintain various resources and data associated with the data processing system 205. The database 215 may include a database management system (DBMS) to arrange and organize the data maintained thereon. The database 215 may be in communication with the data processing system 205 and the one or more data sources 210 via the network 220. While running various operations, the data processing system 205 may access the database 215 to retrieve data from the database 215 and write new data onto the database 215.

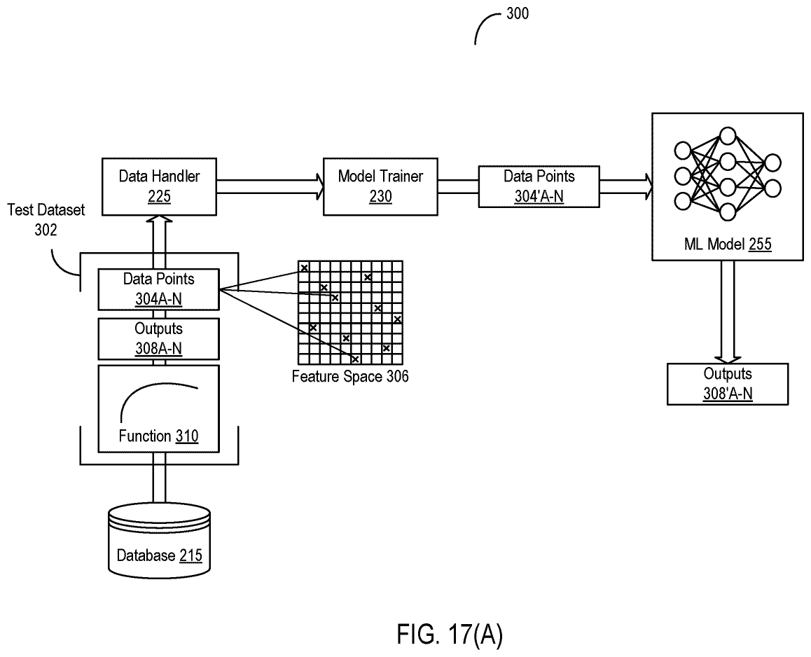

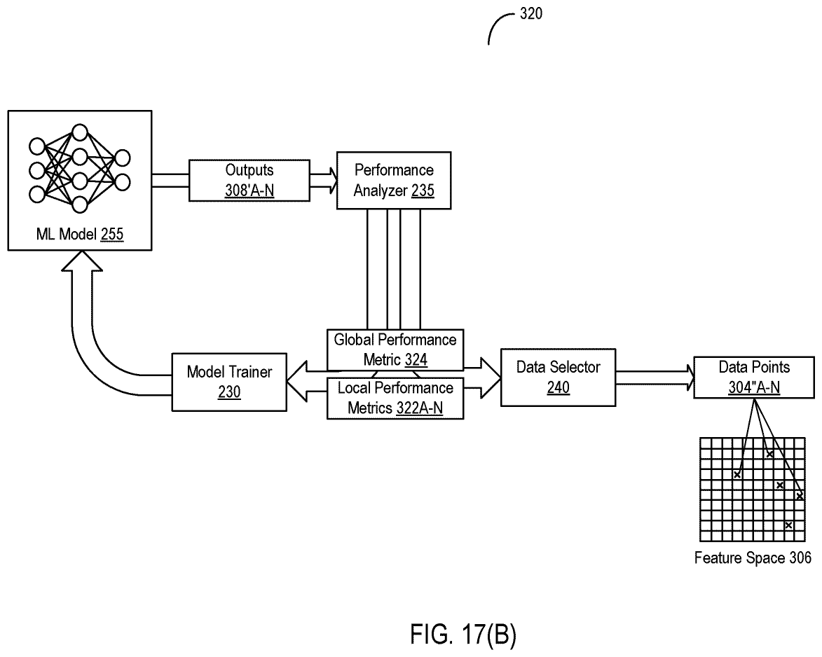

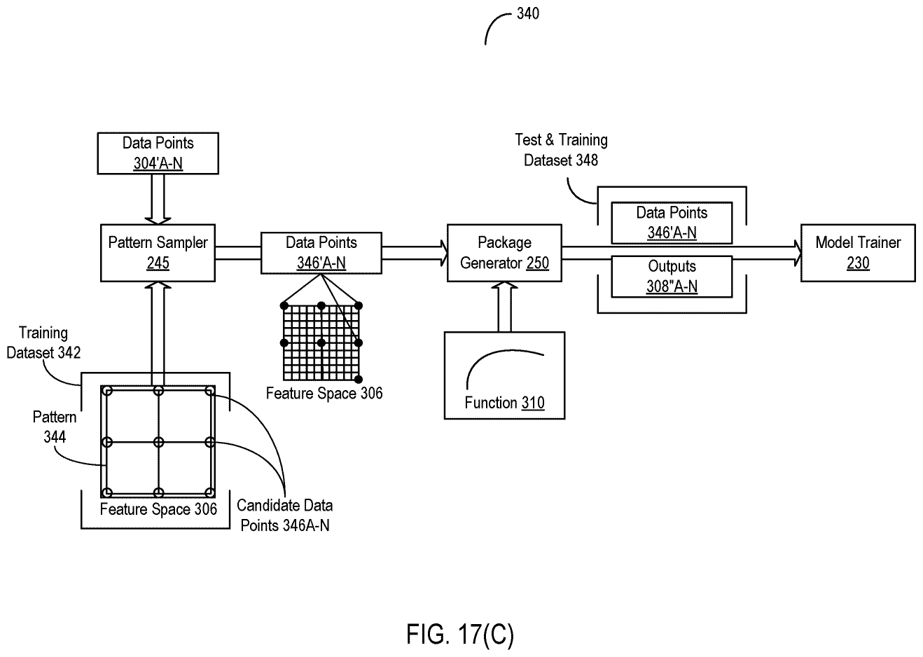

Referring now to FIG. 17(A), among others, depicted is a block diagram of a process 300 for applying training data to machine learning models in the system 200 for training the machine learning model. The process 300 may include or correspond to operations in the system 200 to retrieve datasets to be used to train the ML model 255. Under the process 300, the data handler 225 executing on the data processing system 205 may retrieve, receive, or otherwise identify at least one test dataset 302 from the database 215. In some embodiments, the data handler 225 may retrieve, receive, or identify the test dataset 302 from at least one of the data sources 210.

The test dataset 302 may identify or include a set of data points 304A-N (hereinafter generally referred to as data points 304). The data points 304 (sometimes herein referred to as feature vectors) may be defined in at least one feature space 306. Each data point 304 may correspond to a unit of data in the feature space 306. The feature space 306 may specify, identify, or otherwise define possible values for the data points defined therein. The feature space 306 may be n-dimensional for the range of possible values therein. Each data point 304 may be defined in terms of the n dimensions of the feature space 306. For example, when the feature space 306 is a three-dimensional cartesian system, the data point may be defined in terms of x, y, and z variables. The test dataset 302 may identify or include a set of outputs 308A-N (hereinafter generally referred to as outputs 308) corresponding to the set of data points 304 in accordance with at least one function 310 to be performed. Each output 308 may identify, define, or otherwise correspond to an expected value when the respective data point 304 is evaluated against the function 310.

The function 310 may specify or define a mapping between the values of the data point 304 and the corresponding output 308. In some embodiments, the test dataset 302 may include or identify a definition (e.g., the mapping) for the function 310. In some embodiments, the function 310 may include a multi-variate function derived from empirical measurements (e.g., using instrumentation or sensor). The function 310 may be complex and computationally costly to evaluate. The function 310 may have any number of local and global extrema (e.g., minima and maxima). In some embodiments, the function 310 may include or define pavement design mechanistic-empirical (ME) design. The pavement ME design may be used to model structural responses, including strain, stresses, or deflections, and the corresponding fatigue damage undergone by the pavement as a result of the application of a load (e.g., vehicle or objects). The set of data points 304 may include a corresponding set of variables associated with a pavement. The set of outputs 308 may identify fatigue damage to the pavement.

In some embodiments, the data handler 225 may create, produce, or otherwise generate the test dataset 302. In some embodiments, the data handler 225 may generate additional data points to be used along with the initial data points 304 as a training set of data points 304′ for the ML model 255. To generate the data points 304, the data handler 225 may use sampling within the feature space 306. The sampling may include, for example, random sampling (e.g., using a pseudo-random generator), Latin Hypercube Sampling (LHS), and Orthogonal Array Sampling (OAS), among others. With the generation of the data points 304, the data handler 225 may produce, derive, or otherwise generate the corresponding set of outputs 308 in accordance with the function 310. For each data point 304, the data handler 225 may evaluate the data point 304 against the function 310 to output the corresponding output 308. The data handler 225 may traverse over the set of data points 304 to generate the expected outputs 308, and may include the set of data points 304 and the outputs 308 in the training dataset 302. Upon generation, the data handler 225 may add, insert, or otherwise include the additional data points with the data points 304.

The model trainer 230 executing on the data processing system 205 may apply the set of data points 304′ to the ML model 255 to generate a set of outputs 308′A-N (hereinafter generally referred to as outputs 308′). The set of data points 304′ (sometimes referred to herein as a training dataset) may include the data points 304 of the original test dataset 302 and the additional data points generated for training the ML model 255. From the test dataset 302, the model trainer 230 may obtain, retrieve, or otherwise identify a data point 304′. With the identification, the model trainer 230 may input or feed the data point 304′ to the ML model 255. Upon feeding, the model trainer 230 may process the data point 304′ in accordance with the set of weights of the ML model 255. From processing, the model trainer 230 may produce, output, or otherwise generate a corresponding output 308′ to include in the set of outputs 308′. The model trainer 230 may traverse over the set of data points 304′ of the test dataset 302.

Upon generation, the model trainer 230 may determine whether there are additional data points 304′ to input to the ML model 255. If there are more, the model trainer 230 may identify the next data point 304′ and repeat the functionality detailed herein. In contrast, if there are no more data points 304′, the model trainer 230 may cease or stop traversing through the test dataset 302. In some embodiments, the generation of the test dataset 302 may be performed at least in partial concurrence with the application of data points 304′ into the ML model 255.

Referring now to FIG. 17(B), among others, depicted is a block diagram of a process 320 for evaluating model performance in the system 200 for training the machine learning model. The process 320 may include or correspond to operations within the system 200 to evaluate the performance of the ML model 255 and the individual input data points 304′. Under the process 320, the performance analyzer 235 executing on the data processing system 205 may calculate, generate, or otherwise determine a set of local performance metrics 322A-N (hereinafter generally referred to as local performance metrics 322) for the corresponding set of inputs 304′. Each local performance metrics 322 may define, identify, or correspond to a degree of deviation between the expected output 308 and the output 308′ produced by the ML model 255 for the input data point 304′.

To determine this, the performance analyzer 235 may select or identify the output 308 corresponding to the input data point 304′ applied to the ML model 255 from the test dataset 302. With the identification, the performance analyzer 235 may compare the expected output 308 and the generated output 308′ to generate the local performance metric 322. The performance metric 322 may be calculated in accordance with a loss function, such as a mean square error (MSE), quadratic loss, cross-entropy loss, or a distance function (e.g., L2 or L3), among others. The performance analyzer 235 may traverse over the set of data points 304′ of the test dataset 302 and generate the set of local performance metrics 322 for the corresponding set of data points 304′.

Using the set of local performance metrics 322, the performance analyzer 235 may calculate, generate, or otherwise determine at least one global performance metric 324 for the ML model 255. The global performance metric 324 may measure or correspond to an overall performance of the ML model 255 based on accuracy of the outputs 308. The global performance metric 324 may define, identify, or correspond to a degree of deviation of the outputs 308′ from the ML model 255 with the expected outputs 308 over all the input data points 304′ of the test dataset 302. In some embodiments, the performance evaluator 235 may determine the global performance metric 324 based on a combination of the set of local performance metrics 322. The combination may include, for example, an average or a weighted average (e.g., an ensemble mean) of the values of the local performance metrics 322.

The model trainer 230 may modify, change, or otherwise update at least one weight of the ML model 255 using the performance metric (e.g., the global performance metric 324 or the set of local performance metrics 322). The performance metric may be used as a loss or error metric to update the values of the set of weights in the ML model 255. The updating of the ML model 255 may be in accordance with an optimization function (or an objective function) for the classification. The optimization function may define one or more rates or parameters at which the weights of the ML model 255 are to be updated. The updating of the weights may be repeated until convergence. The model trainer 230 can update the ML model 255 in accordance with the performance metric. For example, the model trainer 230 can update at least one weight of the ML model 255 based on the performance metric. For example, the weight of the ML model 255 may be modified or updated using the performance metric in accordance with an objective function (e.g., stochastic gradient descent (SGD), adaptive motion estimation (ADAM), or adaptive gradient algorithm (AdaGrad)). The ML model 255 may be iteratively updated until convergence to complete the training.

The model trainer 230 may identify or determine whether to retrain the ML model 255 based on a training criteria. The training criteria may define or include conditions under which to continue or stop retraining of the ML model 255. In some embodiments, the training criteria may identify or include a maximum number of iterations. The model trainer 230 may identify a number of iterations in which the ML model 255 has been trained. Each iteration may correspond to an application of the data points 304′ from the test dataset 302 and updating of the weights of the ML model 255. If the number of iterations is less than the maximum number, the model trainer 230 may determine to continue retraining the ML model 255. Otherwise, if the number of iterations is greater than or equal to the maximum number, the model trainer 230 may determine to stop retraining the ML model 255.

In some embodiments, the training criteria may identify or include a threshold for the global performance metric 324. The threshold may define or identify a value for the global performance metric 324 at which to stop further retraining of the ML model 255. If the global performance metric 324 does not satisfy (e.g., greater than or equal to) the threshold defined by the training criteria, the model trainer 230 may determine to continue retraining of the ML model 255. On the other hand, if the global performance metric 324 satisfies (e.g., less than) the threshold, the model trainer 230 may determine to cease or stop further retraining of the ML model 255. Other conditions may be used for the training criteria to determine whether to continue or stop retraining the ML model 255.

The data selector 240 executing on the data processing system 205 may identify or select a subset of data points 304″A-N (hereinafter generally referred to as subset of data points 304″) from the overall set of data points 304′ (or the set of data points 304″). The subset may include data points to be used to generate data points for retraining the ML model 255 (e.g., during the next iteration of training). The selection may be based on the local performance metric 322 for each of the overall set of data points 304. In some embodiments, the data selector 240 may select the subset of data points 304″, when the determination is to continue retraining the ML model 255. To select the subset of data points 304″, the data selector 240 may use a threshold. The threshold value may delineate, define, or otherwise identify a value for the local performance metric 322 at which to include the corresponding data point 304′ into the subset of data points 304″. The threshold for the performance metric may be fixed or dynamic. For instance, the threshold may be assigned or set such that 15% of outputs are identified as poor-performing, or those testing data points with local performance worse than the pre-defined global performance threshold.

For each data point 304′, the data selector 240 may compare the corresponding local performance metric 322 with the threshold value. If the local performance metric 322 is greater than or equal to the threshold value, the data selector 240 may add, insert, or otherwise include the corresponding data point 304′ into the subset of data points 304″. The subset of data points 304″ may each correspond to a respective data point 304′ with the local performance metric 322 above the threshold value. Conversely, if the local performance metric 322 is less than the threshold value, the data selector 240 may remove or exclude the corresponding data point 304′ from the subset of data points 304″. The corresponding data point 304′ may also be removed or excluded from retraining the ML model 255. In some embodiments, the data selector 240 may include the data point 304′ with the local performance metric 322 lower than the threshold value in another subset of data points 304″ identified as to be excluded.

Referring now to FIG. 17(C), among others, depicted is a block diagram of a process 340 for sampling data points for retraining in the system 200 for training the machine learning model. The process 340 may include or correspond to operations in the system 200 to generate additional data points to be used in the retraining of the ML model 255. The pattern sampler 245 executing on the data processing system 205 may retrieve or identify a training dataset 342 from the database 215. The training dataset 342 may be used to facilitate retraining of the ML model 255 using surrogate model techniques. In some embodiments, the pattern sampler 245 may produce, create, or otherwise generate the training dataset 342.

The training dataset 342 may identify, define, or otherwise include at least one pattern 344 (sometimes herein referred to as a grid or mesh array). The pattern 344 may identify or include a set of candidate data points 346A-N (hereinafter generally referred to as candidate data points 346). Each candidate data point 346 may be defined in the same feature space 306 as the original set of data points 304. The pattern 344 may identify, include, or otherwise correspond to a grid, mesh, or other array specifying, identifying, or otherwise defining candidate data points 346 in the feature space 306 for the training dataset 342. The pattern 344 may be defined in accordance with design of experiment (DoE) techniques, such as factorial sampling, central composite design, or uniform sampling, among others In some embodiments, the training dataset 342 may identify or include a set of patterns 344 defined in the feature space 306. Each pattern 344 may have a resolution for the set of candidate data points 346 defined within the feature space 306. The resolution may define a density or sparsity of candidate data points 346 over the feature space 306.

From the training dataset 342, the pattern sampler 245 may retrieve, obtain, or otherwise identify the pattern 344. In some embodiments, the pattern sampler 245 may determine or identify the number of iterations that the ML model 255 has been trained. Each iteration may correspond to an application and updating of the weights of the ML model 255. Using the number of iterations, the pattern sampler 245 may select or identify the pattern 344 from the set of patterns 344 of the training dataset 342. The pattern 344 may define or have the resolution corresponding to the number of iterations. In some embodiments, the pattern sampler 245 may create, produce, or otherwise generate the pattern 344 based on the identified number of iterations. The pattern 344 may be generated to include the candidate data points 346 defined within the feature space 306 in accordance with the resolution.

With the identification, the pattern sampler 245 may identify, determine, or otherwise select a subset of data points 346′A-N (hereinafter generally referred to as data points 346′) from the set of candidate data points 346 using the set of data points 304′. In some embodiments, the pattern sampler 245 may identify the subset of candidate data points 346 using the pattern 344 defined in the feature space 306. To select, the pattern sampler 245 may calculate, generate, or otherwise determine a distance between each data point 304″ and at least one candidate data point 346 in the pattern 344. The distance may identify or correspond to a degree of separation between the data point 304″ and the candidate data point 346 within the feature space 306. The distance may be determined in accordance with a Euclidean distance, a L1 normal distance, a Minkowski distance, or a Chebyshev Distance, among others.

Continuing on, the pattern sampler 245 may compare the distance to a threshold value. The threshold may define a value of the distance at which to select the candidate data point 346 to be used to retrain the ML model 255. When the distance satisfies (e.g., less than or equal to) the threshold, the pattern sampler 245 may identify or select the data point 346 to add or include in the subset of data points 346′. In contrast, when the distance does not satisfy (e.g., greater than) the threshold, the pattern sampler 245 may discard or exclude the data point 346 from the subset of data points 346′. In some embodiments, the pattern sampler 245 may exclude data points 346 using the subset of data points 304′ with local performance metrics 322 below the threshold value. For example, the pattern sampler 245 may exclude data points 346 with distances within the threshold with data points 304′ having the local performance metrics 322 below the threshold value.

The package generator 250 executing on the data processing system 205 may create, produce, or otherwise generate at least one new test and training dataset 348. To generate, the package generator 250 may calculate, generate, or otherwise determine a set of outputs 308″A-N (hereinafter generally referred to as outputs 308″) for the set of data points 346′ in accordance with the function 310. The set of data points 346′ may include the data points 346 and the data points 304″. For each data point 346′, the package generator 250 may evaluate against the function 310 to generate a corresponding output 308″. The package generator 250 may traverse over the set of data points 346′ to generate the expected outputs 308″, and may include the set of data points 346′ and the outputs 308″.

With the determination of the outputs 308″, the package generator 250 may generate the dataset 348 to include the set of data points 346′ and the corresponding set of outputs 308″. In some embodiments, the package generator 250 may include the data points 304″ and the corresponding outputs 308′ into the new dataset 348. Because of the use of the pattern 344, the set of data points 346′ of the new dataset 348 may be greater in number than the original set of data points 304 in the test dataset 302. Likewise, the set of outputs 308″ may be greater in number than the set of outputs 308.

Using the dataset 348, the model trainer 230 may retrain the ML model 255 using the set of data points 346′ and the corresponding set of outputs 308″. The model trainer 230 along with the remainder of the data processing system 205 may repeat the functionalities detailed herein to further train the ML model 255. In this manner, by using the pattern 344, the data processing system 205 may supplement additional data points 346′ to include in the dataset 348. With the addition of data points 346′, the data processing system 205 may be able to train the ML model 255 to accurately and precisely simulate or approximate the function 310, which may be complex with the use of multiple variables and computationally expensive to evaluate. Using finer resolutions for the pattern 344 from which to select data points 346′, the data processing system 205 may be able to train the ML model 255 to hone in on local maxima and minima of the function 310. Once trained, the ML model 255 may be used in place of the more computationally complex and costly function 310 to evaluate input data. The ML model 255 may thus be able to reduce the consumption of computing resources, such as processing power and memory, in evaluating input data while maintaining accuracy of the output.

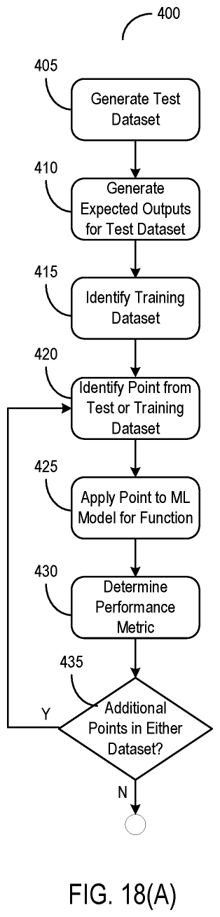

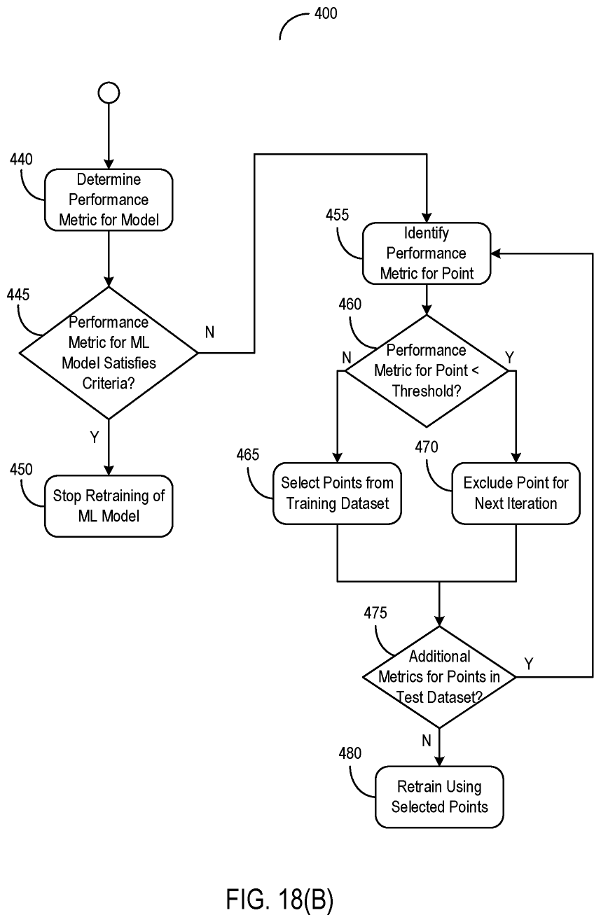

Referring now to FIGS. 18(A) and 18(B), depicted is a flow diagram of a method 400 of training machine learning (ML) models. The method 400 may be implemented using or performed by one or more processors of a computing system detailed herein conjunction with FIG. 19. In overview, under the method 400, a computing system may generate a testing dataset (405). The computing system may generate expected outputs for testing dataset (410). The computing system may identify a training dataset in a feature space (415). The computing system may identify a point from the testing or training dataset (420). The computing system may apply the point to a machine learning (ML) model to generate an output (425). The computing system may determine a performance metric for the output (430). The computing system may determine whether there are more points in the testing or training dataset (435). If there are no more, the computing system may determine a performance metric for the ML model (440). The computing system may determine whether the performance metric for the ML model satisfies a criteria (445). If the performance metric satisfies the criteria, the computing system may cease retraining of the ML model (450). Otherwise, if the performance metric for the ML model does not satisfy the criteria, the computing system may identify the performance metric for a point (455). The computing system may determine whether the performance metric is less than a threshold (e.g., a tolerance) (460). If the performance metric is greater than or equal to the threshold, the computing system may select points from the candidate training dataset (465). Otherwise, if the performance metric is less than the threshold, the computing system may exclude the point for a next iteration (470). The computing system may determine whether there are any additional performance metrics to analyze (475). If there are none, the computing system may retrain the ML model using the selected points and outputs for the next iteration (480).

In further detail, a computing system may create, produce, or otherwise generate a testing dataset for training a machine learning (ML) model (405). The testing dataset may include or identify a set of data points (sometimes herein referred to as feature vectors) defined in a feature space. Each data point may correspond to a unit of data in the feature space. The set of data points may be generated using sampling within the feature space, such as random sampling, Latin Hypercube Sampling (LHS), and Orthogonal Array Sampling (OAS), among others. The feature space may specify, identify, or otherwise define possible values for the data points defined therein. The feature space may be n-dimensional for the range of possible values therein. Each data point of the set may be defined in terms of the n dimensions of the feature space.

The computing system may also calculate, determine, or otherwise generate corresponding outputs for the testing dataset (410). The computing system may determine the expected output for each data point of the testing dataset in accordance with the function. Using the function, the computing system may determine the expected output for the selected data point into the function. With the generation, the computing system may include the output with the corresponding data point into the testing dataset for training the ML model. The computing system may store and maintain the testing dataset including the data point and the expected output.

The computing system may determine, generate, or otherwise identify a training dataset (e.g., of candidate training points) using a pattern (e.g., grid or mesh array of candidate training points) defined in the feature space (415). The candidate training dataset may be used to facilitate retraining using surrogate model techniques, upon applying the original training dataset. The training dataset may include or identify a set of data points defined in the same feature space as the set of data points. The pattern may be, include, or otherwise describe a grid, mesh, or other array specifying, identifying, or otherwise defining data points in the feature space for the training dataset. The density or sparsity of the pattern (e.g., of training points selected for training the ML model) within the feature space may depend on an iteration of the training. For instance, in general, the density of (the training points used for training, from) the pattern may increase with successive iterations (or epochs). Using the pattern, the computing system may generate the set of data points to include into the training dataset. Each data point in the set of data points for the training dataset may correspond to a unit of data in the feature space.

The training dataset may also include or identify a set of outputs expected for the set of data points in accordance with at least one function to be performed. For each data point of the set, the training dataset may identify a respective expected output. The outputs may be of m dimensions, independent of the number of n dimensions of the input data points. The function may define a mapping or a relationship between input data points and outputs. The function may model, simulate, or otherwise approximate a behavior between the input data points and the outputs. The function may be, for example, a Shekel function, a peak function, or an Ackley function, among others.

The computing system may select or identify a data point from the set of data points of the testing or training dataset (420). The computing system may iterate through the set of data points to feed or provide for training the ML model. The ML model may include any algorithm or model to reproduce, model, or approximate the function between the input data points and the outputs. The ML model may include, for example, an artificial neural network (ANN), a regression model (e.g., linear or logistic), a support vector machine (SVM), random forests, or a Bayes network, among others. In general, the ML model may include a set of weights in accordance with an architecture for the algorithm. The set of weights may represent or correspond to a relationship between the inputs and outputs out the ML model.

The computing system may apply the data point to the ML model to generate an output (425). In applying, the computing system may feed the input data point into the input of the ML model. The ML model may have an input corresponding the n dimensions as defined in the feature space. The computing system may process the input data point from the dataset (e.g., training or testing dataset) in accordance with the set of weights of the ML model. From processing, the computing system may generate an output corresponding to the input. The output of the ML may be of the same form of the expected output that the dataset generated using the function.

The computing system may calculate, generate, or otherwise determine a performance metric (also referred to as a loss metric) for the output (430). To determine, the computing system may select or identify the expected output corresponding to the input data point applied to the ML model from the dataset (e.g., training or testing dataset). With the identification, the computing system may compare the expected output of the dataset with the output generated from the ML model for the input data point. Based on the comparison, the computing system may calculate the performance metric to indicate a degree of difference between the expected output and the output for the given input data point. The performance metric may be calculated in accordance with a loss function, such as a mean square error (MSE), quadratic loss, cross-entropy loss, or a distance function (e.g., L2 or L3), among others. When the data point input into the ML model is from the training dataset, the computing system may update one or more weights of the ML model using the performance metric. The inputs and outputs from the training dataset may be used in training and updating of the weights in the ML model.

The computing system may identify or determine whether there are more data points in the set of data points from the testing or training dataset (435). The computing system may traverse through the data points of both of the datasets to apply to the ML model. If there are more data points in either dataset, the computing system may determine to continue training for the same iteration, and can identify the next data point in the dataset. If there are no more data points left in the dataset, the computing system may determine that the iteration of training is complete. Since adaptive surrogate modeling techniques are used in conjunction with the candidate dataset, the number of data points used for training may be less than other techniques for training AI models.

In addition, the computing system may determine a performance metric for the ML model (440). The computing system may determine the performance metric for the ML model based on a combination (e.g., an average or weighted average) of the performance metric for each data point in the testing dataset. The computing system may determine whether the performance metric for the ML model satisfies a criteria (445). The criteria may include, for example, a threshold value for the performance metric. The threshold value may define a value for the performance metric at which to continue or stop further training of the ML model. The training may include at least the application and updating of the set of weights of the ML model. If the performance metric satisfies (e.g., greater than or equal to) the criteria, the computing system may cease retraining of the ML model (450).

If the performance metric for the ML model does not satisfy (e.g., more than) the criteria, the computing system may select or identify the performance metric for a data point of the set of input data points of the testing dataset (455). The computing system may iterate through the performance metrics determined for the data points of the testing dataset to evaluate the deviation of the output for each input data point from the expected output. The computing system may determine whether the performance metric is less than a threshold (460), such as a tolerance (for MSE for instance). The threshold may define a value for the performance metric at which the corresponding output is determined to be well-performing or poor-performing. The threshold for the performance metric may be fixed or dynamic. For instance, the threshold may be assigned or set such that 15% of outputs are identified as poor-performing.

If the performance metric is greater than or equal to the threshold, the computing system may find, identify, or otherwise select (additional) data points from the candidate training dataset using the information obtained from the poor-performing data point of the testing dataset (465). The computing system may also determine or identify the data point from the set of data points of the testing dataset as poor-performing. In addition, the computing system may identify the one or more data points from the set of data points of the candidate training dataset based on distances to the input data point of the testing dataset as defined in the feature space. The one or more data points may be identified from within the feature space using design of experiment (DoE) techniques, such as factorial sampling, central composite design, or uniform sampling, among others. For instance, the computing system may find a subset of data points from the training dataset most proximate to the input data point of the testing dataset in the feature space (e.g., considering that there may be a local extrema to be more fully characterized by the ML model).

Otherwise, if the performance metric is within or less than the threshold, the computing system may remove, discard, or otherwise exclude the data point from the next iteration of training the ML model (470). The computing system may determine or identify the data point from the set of data points of the testing dataset as well-performing. With the identification, the computing system may exclude the well-performing data point from the testing dataset and any corresponding candidate training dataset for the next iteration for training the ML model.

The computing system may determine whether there are any additional performance metrics to analyze (475). The computing system may iterate through the performance metrics determined for the data points of the training and testing dataset. If there are more performance metrics, the computing system may continue analyzing performance metrics for the current iteration. If there are no more performance metrics left in the training and testing dataset, the computing system may determine that the iteration of training is complete. The training dataset for the next iteration may now include a new set of data points selected from the candidate training set along with the set of expected outputs for the data points in accordance with the function.

In addition, the computing system may retrain or update the ML model using the selected points and outputs for the next iteration (480). In addition, the computing system may retrain with the data points from the current (and previous) iterations. The computing system may repeat the method 400 for a set or capped number of iterations (or epochs), or until the performance metric(s) are within defined threshold(s) or tolerance(s). With each subsequent iteration, the pattern used/established to generate the data point for the candidate dataset may have higher and higher density defined within the feature space.

### D. Network Environment and Computing Environment

Various operations described herein can be implemented on one or more computer systems. FIG. 5 shows a block diagram of a representative computing system 514 usable to implement the present disclosure. Computing system 514 can be implemented, for example, as a consumer device such as a smartphone, other mobile phone, tablet computer, wearable computing device (e.g., smart watch, eyeglasses, head mounted display), desktop computer, laptop computer, cloud computing service or implemented with distributed computing devices. In some embodiments, the computing system 514 can include computer components such as processing units 516, storage device 518, network interface 520, user input device 522, and user output device 524.

Network interface 520 can provide a connection to a wide area network (e.g., the Internet) to which WAN interface of a remote server system is also connected. Network interface 520 can include a wired interface (e.g., Ethernet) and/or a wireless interface implementing various RF data communication standards such as Wi-Fi, Bluetooth, or cellular data network standards (e.g., 3G, 5G, 5G, 60 GHz, LTE, etc.).

User input device 522 can include any device (or devices) via which a user can provide signals to computing system 514; computing system 514 can interpret the signals as indicative of particular user requests or information. User input device 522 can include any or all of a keyboard, a controller (e.g., joystick), touch pad, touch screen, mouse, or other pointing device, scroll wheel, click wheel, dial, button, switch, keypad, microphone, sensors (e.g., a motion sensor, an eye tracking sensor, etc.), and so on.

User output device 524 can include any device via which computing system 514 can provide information to a user. For example, user output device 524 can include a display to display images generated by or delivered to computing system 514. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. User output devices 524 can be provided in addition to or instead of a display. Examples include indicator lights, speakers, tactile “display” devices, printers, and so on.

Some implementations include electronic components, such as microprocessors, storage, and memory that store computer program instructions in a non-transitory computer readable storage medium. Many of the features described in this specification can be implemented as processes that are specified as a set of program instructions encoded on a computer readable storage medium. When these program instructions are executed by one or more processors, they cause the processors to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processing unit 516 can provide various functionality for computing system 514, including any of the functionality described herein as being performed by a server or client, or other functionality associated with message management services.

It will be appreciated that computing system 514 is illustrative and that variations and modifications are possible. Computer systems used in connection with the present disclosure can have other capabilities not specifically described here. Further, while computing system 514 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed in connection with one implementation are not intended to be excluded from a similar role in other implementations or implementations.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate, or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers, and modules described in the present disclosure. The memory may be or include volatile memory or non-volatile memory, and may include database components, object code components, script components, or any other type of information structure for supporting the various activities and information structures described in the present disclosure. According to an embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage, or other magnetic storage devices, or any other medium which can be used to carry or store desired program code in the form of machine-executable instructions or data structures which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including”, “comprising”, “having”, “containing”, “involving”, “characterized by”, “characterized in that”, and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation”, or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements. Technical and scientific terms used herein have the meanings commonly understood by one of ordinary skill in the art, unless otherwise defined. Any suitable materials and/or methodologies known to those of ordinary skill in the art can be utilized in carrying out the methods described herein.

Systems and methods described herein may be embodied in other specific forms without departing from the characteristics thereof. As used herein, “approximately,” “about”, “substantially”, or other terms of degree will be understood by persons of ordinary skill in the art and will vary to some extent on the context in which it is used. If there are uses of the term which are not clear to persons of ordinary skill in the art given the context in which it is used, references to “approximately,” “about”, “substantially”, or other terms of degree shall include variations of +/−10% from the given measurement, unit, or range unless explicitly indicated otherwise.

Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes, and proportions of the various elements, values of parameters, mounting arrangements, use of materials, colors, and orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

As used herein, a subject can be a mammal, such as a non-primate (e.g., cows, pigs, horses, cats, dogs, rats, etc.) or a primate (e.g., monkey and human). In certain embodiments, the term “subject,” as used herein, refers to a vertebrate, such as a mammal. Mammals include, without limitation, humans, non-human primates, wild animals, feral animals, farm animals, sport animals, and pets. In certain exemplary embodiments, a subject is a human.

As used herein, the terms “subject” and “user” are used interchangeably.

Unless otherwise defined, all technical and scientific terms used herein have the same meaning as commonly understood by one ordinary skill in the art to which this disclosure belongs. Although methods and materials similar or equivalent to those described herein can be used in the practice or testing of the present disclosure, suitable methods and materials are described herein.

As used herein, the singular forms “a”, “an,” and “the” include plural referents unless the context clearly indicates otherwise. For example, the term “a cell” includes a plurality of cells, including mixtures thereof.

As used herein, the term “about” is used to indicate that a value includes the standard deviation of error for the device or method being employed to determine the value. The term “about” when used before a numerical designation, e.g., temperature, time, amount, and concentration, including range, indicates approximations which may vary by (+) or (−) 15%, 10%, 5%, 3%, 2%, or 1%.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all of the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

What is claimed is:

1. A method of training machine learning (ML) models, comprising:
identifying, by one or more processors, a testing dataset identifying (i) a first plurality of data points defined in a feature space and (ii) a first plurality of outputs expected for the corresponding first plurality of data points in accordance with a function to be performed;
applying, by the one or more processors, the first plurality of data points to a ML model to generate a corresponding second plurality of outputs;
determining, by the one or more processors, a performance metric for each data point of the first plurality of data points according to a comparison between a first output of the first plurality of outputs and a second output of the second plurality of outputs;
identifying, by the one or more processors, from the first plurality of data points, a first subset of data points based on the performance metric for each data point of the first plurality of data points;
selecting, by the one or more processors, from a second plurality of data points defined in the feature space for the function, a second subset of data points using the first subset of data points; and
retraining, by the one or more processors, the ML model using the second subset of data points and a corresponding third plurality of outputs in accordance with the function.

2. The method of claim 1, further comprising:
identifying, by the one or more processors, using a pattern defined in the feature space, the second plurality of data points; and
generating, by the one or more processors, the third plurality of outputs corresponding to the second plurality of data points according to the function.

3. The method of claim 1, further comprising:
identifying, by the one or more processor, a number of iterations that the ML model has been trained; and
selecting, by the one or more processors, from a plurality of patterns defined in the feature space, a pattern with which to identify the second plurality of second data points, the pattern having a resolution corresponding to the number of iterations.

4. The method of claim 1, further comprising determining, by the one or more processors, a second performance metric of the ML model, according to the comparison for each data point of the first plurality of data points; and
wherein retraining the ML model further comprises retraining the ML model using the second subset of data points, responsive to the second performance metric not satisfying a training criteria.

5. The method of claim 1, further comprising:
determining, by the one or more processors, a second performance metric of the ML model, according to the comparison for each data point of the first plurality of data points; and
determining, by the one or more processors, to stop additional retraining of the ML model, responsive to the second performance metric satisfying a training criteria.

6. The method of claim 1, further comprising:
identifying, by the one or more processors, from the first plurality of data points, a third subset of data points each corresponding to the performance metric being less than a threshold value; and
excluding, by the one or more processors, from retraining of the ML model, a fourth subset of data points selected from the second plurality of data points using the third set of data points.

7. The method of claim 1, wherein identifying the first subset of data points further comprises identifying the first subset of data points each corresponding to the performance metric being greater than or equal to a threshold value.

8. The method of claim 1, wherein selecting the second subset of data points further comprises identifying, for each first data point of the first subset of data points, at least one second point from the second plurality of data points based on a distance between the first data point of the first subset of data points and the at least one second data point.

9. The method of claim 1, wherein the function comprises a multi-variate function derived from empirical measurements having one or more local extrema within the feature space.

10. The method of claim 1, wherein the function which the ML model is to stimulate comprises a pavement design mechanistic-empirical (ME) design; the first plurality of data points include a corresponding plurality of variables associated with pavement; and the first plurality of outputs identify fatigue damage to the pavement.

11. A system for training machine learning (ML) models, comprising:
one or more processors, configured to:
identify a testing dataset identifying (i) a first plurality of data points defined in a feature space and (ii) a first plurality of outputs expected for the corresponding first plurality of data points in accordance with a function to be performed;
apply the first plurality of data points to a ML model to generate a corresponding second plurality of outputs;
determine a performance metric for each data point of the first plurality of data points according to a comparison between a first output of the first plurality of outputs and a second output of the second plurality of outputs;
identify, from the first plurality of data points, a first subset of data points based on the performance metric for each data point of the first plurality of data points;
select, from a second plurality of data points defined in the feature space for the function, a second subset of data points using the first subset of data points; and
retrain the ML model using the second subset of data points and a corresponding third plurality of outputs in accordance with the function.

12. The system of claim 11, wherein the one or more processors are further configured to:
identify, using a pattern defined in the feature space, the second plurality of data points; and
generate the third plurality of outputs corresponding to the second plurality of data points according to the function.

13. The system of claim 11, wherein the one or more processors are further configured to:
identify a number of iterations that the ML model has been trained; and
select, from a plurality of patterns defined in the feature space, a pattern with which to identify the second plurality of second data points, the pattern having a resolution corresponding to the number of iterations.

14. The system of claim 11, wherein the one or more processors are further configured to:
determine a second performance metric of the ML model, according to the comparison for each data point of the first plurality of data points, and
retrain the ML model using the second subset of data points, responsive to the second performance metric not satisfying a training criteria.

15. The system of claim 11, wherein the one or more processors are further configured to:
determine a second performance metric of the ML model, according to the comparison for each data point of the first plurality of data points; and
determine to stop additional retraining of the ML model, responsive to the second performance metric satisfying a training criteria.

16. The system of claim 11, wherein the one or more processors are further configured to:
identify, from the first plurality of data points, a third subset of data points each corresponding to the performance metric being less than a threshold value; and
exclude, from retraining of the ML model, a fourth subset of data points selected from the second plurality of data points using the third set of data points.

17. The system of claim 11, wherein the one or more processors are further configured to identify the first subset of data points each corresponding to the performance metric being greater than or equal to a threshold value.

18. The system of claim 11, wherein the one or more processors are further configured to identify, for each first data point of the first subset of data points, at least one second point from the second plurality of data points based on a distance between the first data point of the first subset of data points and the at least one second data point.

19. The system of claim 11, wherein the function comprises a multi-variate function derived from empirical measurements having one or more local extrema within the feature space.

20. The system of claim 11, wherein the function which the M model is to stimulate comprises a pavement design mechanistic-empirical (ME) design; the first plurality of data points include a corresponding plurality of variables associated with pavement; and the first plurality of outputs identify fatigue damage to the pavement.
